SEQUENCE LISTING (2 sequences)

SEQ ID NO: 1 - protein, 279 aa, Sus scrofa
  MISC_FEATURE: Amino acids residues 49 to 327 from 1cdk-alpha.
LGTGSFGRVMLVKHKETGNHFAMKILDKQKVVKLKQIEHTLNEKRILQAVNFPFLVKLEYSFKDNSNLYMVMEYVPGGEMFSHLRRIGRFSEPHARFYAAQIVLTFEYLHSLDLIYRDLKPENLLIDQQGYIQVTDFGFAKRVKGRTWTLCGTPEYLAPEIILSKGYNKAVDWWALGVLIYEMAAGYPPFFADQPIQIYEKIVSGKVRFPSHFSSDLKDLLRNLLQVDLTKRFGNLKDGVNDIKNHKWFATTDWIAIYQRKVEAPFIPKFKGPGDTSNF

SEQ ID NO: 2 - protein, 37 aa, Sus scrofa
  MISC_FEATURE: Concatenated subsequence derived from amino acid residues 49 to 327 from 1cdk-alpha.
LGTGSFGRVAKLKVLQHTELVMMEYVEDKENLTDFGF

(19) United States
(12) Patent Application Publication
(10) Pub. No.: US 2003/0149537 A1
(43) Pub. Date: Aug. 7, 2003

(54) Method for matching molecular spatial patterns

(76) Inventors: Thomas Andrew Binkowski, Wheaton, IL (US); Larissa Adamian, Naperville, IL (US); Jie Liang, River Forest, IL (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/306,296

(22) Filed: Nov. 27, 2002

Related U.S. Application Data
(60) Provisional application No. 60/333,969, filed on Nov. 29, 2001.
(60) Provisional application No. 60/334,689, filed on Nov. 30, 2001.

(51) Int. Cl. G06F 19/00

(52) U.S. Cl. 702/27

(57) ABSTRACT

Structural alignment methods are described that compare the sequences of two or more structural features of molecules. The methods provide for a rigorous statistical analysis that can detect structural similarities in molecules regardless of the similarity in their primary sequences. Thus, the methods can be used to predict and explain functional properties of molecules from their three-dimensional conformation. The methods use databases of different structural features against which a query sequence can be searched. By combining the search results from the various databases, the functional properties of molecules can be predicted and serve as a basis for the efficient design of ligands, substrate analogues, inhibitors or pharmaceutical species thereof.

This application claims priority to U.S. provisional application Ser. No. 60/333969 filed Nov. 29, 2001 and to U.S. provisional application Ser. No. 60/334689 filed Nov. 30, 2001, both of which are fully incorporated herein by reference.

### FIELD OF THE INVENTION

This invention relates to molecular classification approaches useful to generate comparisons between molecules and determination of similarities and differences for predicting functional characteristics of molecules.

### BACKGROUND OF THE INVENTION

The completion of the Human Genome Project has identified the sequences of about three billion chemical base pairs that are estimated to encode more than 30,000 human genes. Together with similar genome projects in other important organisms such as mouse, rat, and C. elegans, the amount of genetic information that is or will soon become available is enormous. All the genes identified in these genome projects will eventually be cloned and the proteins they encode will be expressed in order to solve their three-dimensional structures and thereby understand their biological functions. With this rapid accumulation of three-dimensional information about proteins (Bernstein et al., “The Protein Data Bank: A Computer-based Archival File for Macromolecular Structures.”, J. Mol. Biol. (1977); 112:535-542) and the development of protein structure classification systems (Murzin et al., “SCOP: A Structural Classification of Proteins Database for the Investigation of Sequences and Structures.”, J. Mol. Biol. (1995); 247:536-540 and Orengo et al., “CATH—A Hierarchic Classification of Protein Domain Structures.”, Structure (1997);5:1093-1108), protein structural analysis has become an important approach that complements sequence analysis for understanding functions of proteins.

Conservation in protein three-dimensional structures often reveals very distant evolutionary relationships that are difficult or impossible to detect by analyzing only the primary sequence (Todd et al., “Evolution of Function in Protein Superfamilies, From a Structural Perspective.” J. Mol. Biol. (2001); 307:1113-1143). There have been numerous studies where protein three-dimensional structure analysis suggested insightful details about protein functions such as active site location and residues (Holm and Sander, “New Structure: Novel Fold?” Structure (1997); 5:165-171). An important approach used in protein structural studies is fold analysis. Identifying the correct tertiary fold of a protein is often helpful for inferring the function of the protein. There are many examples where fold assignment alone can provide clues to the function of a protein. However, the relationship between protein fold and function is in general very complex (Todd et al., “Evolution of Function in Protein Superfamilies, from a Structural Perspective.” J. Mol. Biol. (2001); 307:1113-1143) since a particular arrangement of a protein fold can be found in related proteins having many different functions (Orengo et al., “The CATH Database Provides Insight into Protein Structure/Function Relationships.” Nucleic Acids Res. (1999); 27:275-279), and a particular biological function can be achieved using proteins having many different structural characteristics.

This complex relationship between structure and function is lucidly illustrated for a subset of proteins whose functional roles are described by the international Enzyme Classification (E.C.) systems. It has been shown that some enzymes belonging to the same E.C. class (and thus having sufficiently similar functions to be classified together) have amino acid sequence identities below 40 percent (Wilson et al. “Assessing Annotation Transfer for Genomics: Quantifying the Relations Between Protein Sequence, Structure and Function Through Traditional and Probabilistic Scores.” J. Mol. Biol. (2000) 297: 233-249). Making useful functional inferences between a pair of proteins having sequence identities below 30 percent is very difficult to accomplish. Jaroszewski and Godzik (“Search for a New Descriptor of Protein Topology and Local Structure.” In: Proceedings of the Eighth International Conference on Intelligent Systems for Molecular Biology (ISMB). AAAI Press, (2000) pp. 211-217) however, demonstrated that if molecular descriptions other than secondary structures are used, significant structural similarities can be found between proteins of different structural classes. Using tenascin (1ten, all β) and phosphotransferase (1poh, α+β) as examples, their results implied that different classification systems of protein structures other than the widely used fold classification could be possible. The results also demonstrate that protein fold analysis can be insufficient to infer the function of a proteins from another protein with similar fold.

A fundamental challenge in identifying protein function from structure is that the functional surface of a protein often involves only a small number of key residues. Proteins play cellular roles by interacting with other molecules. These interacting residues are dispersed in diverse regions of the primary sequence and are difficult to detect if the only information available is the primary sequence. Thus, identifying spatial motifs from structures that are functionally relevant is therefore the only way to identify the function of a protein. Several methods have been developed for analyzing spatial patterns of proteins. Artymiuk et al. (“Identification of β-Sheet Motifs of y-Loops, and of Patterns of Amino Acid Residues in Three-Dimensional Protein Structures Using a Subgraph-Isomorphism Algorithm.”, J. Chem. Information and Computer Sci. (1994a) 34:54-62) developed an algorithm based on subgraph isomorphism detection. By representing residue side chains with simplified pseudo-atoms, a molecular graph is constructed to represent the patterns of side chain pseudo-atoms and their inter-atomic distances. A user-defined query pattern can then be searched rapidly against the Protein Data Bank which can be found at the web site having URL www.rcsb.org/pdb/for similarity relationships. Another widely used approach is the method of geometric hashing first developed in computer vision. By examining spatial patterns of atoms, Fischer et al (“3-D Substructure Matching in Protein Molecules.” CPM (1992) 136-150) developed a geometric hashing algorithm that can detect surface similarities of proteins. This method has also been applied by Wallace et al. (“TESS: A Geometric Hashing Algorithm for Deriving 3D Coordinate Templates for Searching Structural Databases: Application to Enzyme Active Sites. ” Protein Science (1997) 6:2308-2323) for the derivation and matching of spatial templates. Russell (“Detection of Protein Three-Dimensional Side-Chain Patterns: New Examples of Convergent evolution.” J. Mol. Biol. (1998); 279:1211-1227) developed a different algorithm that detects side chain geometric patterns common to two protein structures. Using this method of Russell and with evaluation of statistical significance of the measured root mean square distance (RMSD), several new examples of convergent evolution were discovered where common patterns of side chains geometry were found to reside on different tertiary folds.

The disadvantages of these comparison systems is that they simplify the protein structure and do not evaluate the characteristics of the protein structures in the context of the residues themselves that may be involved in the function of the protein. New statistically rigorous and faster methods for similarity determination are needed that take into account the physicochemical properties of the residues in the functional surfaces as well as their geometric orientation, since both of these properties determine the chemistry of the functional surface. Furthermore, methods of protein spatial motif analysis are needed that can determine similarities, making use of the large amount of genetic and structural data available so that the function of newly discovered genes can be predicted with a high degree of certainty.

In order to develop treatment procedures and new pharmaceuticals against diseases, an adequate understanding of the structural determinants of protein function is needed. The classical method of understanding functions is to design experiments that address specific questions about the role of a particular gene or the protein it encodes. This takes a lot of work and time and the conclusions drawn from these experiments may not be quite clear. One important way to complement and facilitate experimentation is through comparison of the protein with other proteins whose functions are known. This is usually done by primary sequence alignment to discover similarities in the sequences. However, the disadvantage of this system is that function is dependent on the three-dimensional structure of a protein so that residues that are far removed from each other in the primary sequence may be in fact important functional partners. Thus, the preferable comparison is at the three-dimensional level. To this end, the methods described herein relate to similarity determinations that take into account the nature of the surface features as well as their geometric orientation.

### BRIEF DESCRIPTION OF THE FIGURES

FIG. 1 shows the distribution of the number of residues in pocket or void subsequences from: 1(a) the entire pocket database and 1(b) PDBselect database consisting of proteins with 25 percent identity or less.

FIG. 2 illustrates the composition of amino acid residues of the full length protein and of the surface pockets and voids. FIG. 2(a) is all 12,177 PDB structures; 2(b) illustrates PDB structures obtained from PDBselect that differ at 95 percent sequence identity level; 4(c) illustrates PDB structures obtained from PDBselect that differ at 25 percent level; 4(d) illustrates PDB structures containing pockets and voids where residues with known functional roles according to SwissProt are located.

FIG. 3 illustrates the ratios of amino acid residue composition of the full length protein and of the surface pockets and voids. 3(a) shows the ratios for all 12,177 PDB structures; 3(b) shows the ratios for PDB structures obtained from PDBselect that differ at 95 percent sequence identity level; 3(c) shows the ratios for PDB structures obtained from PDBselect that differ at 25 percent level. 3(d) shows the ratios for PDB structures containing pockets and voids where residues with known functional roles according to SwissProt are located. Aromatic residues F, W, and Y are found to be favored in pocket and voids, whereas small residues G, A, S and C are disfavored to be located in pockets and voids. For pockets and voids containing residues with annotated biological functional roles according to SwissProt, aromatic residues W, Y and F, and residue R and H are favored, whereas residues A and K are disfavored.

FIG. 4 illustrates the Dalaunay triangulation from the Voronoi diagram for the calculation of the alpha complex. FIG. 4(a) is the Voronoi diagram, FIG. 4(b) shows how the Delaunay triangulation is used to produce a polygon and FIG. 4(c) depicts the alpha complex.

FIG. 5 illustrates the identification and measurements of the pockets and voids by the discrete flow method. FIG. 5(a) shows a pocket formed by five empty Delaunay triangles: obtuse triangles 1, 4, and 5 flow to the sink, triangle 2. Triangle 3 is also obtuse: it flows to triangle 4, and continues to flow to triangle 2. FIG. 5(b) is a surface depression not identified as a pocket and is formed by five obtuse triangles that flow sequentially from 1 to 5 to the outside, or infinity.

FIG. 6 illustrates how protein motif sequences are created by concatenating residues in the same pocket for cAMP dependent protein kinase (1cdk α): FIG. 3(a) shows a primary sequence, 3(b) shows residues from the same pocket, and 3(c) shows a protein surface motif subsequence. Within this text, proteins are identified by their unique 4-letter Protein Data Bank (PDB) identification followed by their chain identifier (e.g. 2ay5 β). In cases of a single chain protein, the id ‘0’ (zero) is used.

FIG. 7 shows the distribution of Smith-Waterman scores for the zinc binding pocket (9) of hydrolase (1c7k α). 7(a) shows the distribution based upon the pre-packaged FASTA statistical methods. 7(b) shows the distribution after searching temporary database created by removing subsequences with Smith-Waterman scores ≦20 and randomizing the subsequences. For this distribution the Kolmogorov-Smirnov test statistic is equal to 0.045.

FIG. 8 illustrates a flow chart of a preferred method of identifying similar molecular structures.

FIG. 9 depicts an alternative flow diagram of preferred methods of identifying similar molecular structures.

### DETAILED DESCRIPTION OF THE INVENTION

This invention provides sensitive and powerful methods for detecting similarity patterns of surface motifs of molecular sequences. In one embodiment, protein surface motifs are examined by comparing a query protein with a database. Since protein functional surfaces are frequently associated with surface regions of prominent concavity, the focus on surface pockets and voids of a protein structure can provide important information about function. The methods described herein do not require prior knowledge of any similarity in either the primary sequence or the backbone folds. In addition, the methods do not impose any limitation in the size of the spatially derived surface motif and can successfully detect patterns that are small as well as large.

Surface Motifs in Molecules: Surface Pockets and Interior Voids

Molecular surface motifs are spatial patterns on the surfaces of molecules. These surfaces are the parts of the protein structure exposed to the bulk solvent as well as the surfaces buried inside a protein and not exposed to the bulk solvent. For example, a surface motif may be the surfaces of pockets that form concave structural features. Another type of surface motifs is internal voids which are buried inside a molecule. Molecular surface motifs can be found in proteins, DNA, RNA, polysaccharides or in any polymeric or non-polymeric molecule. The atoms or groups of atoms that compose a molecular surface motif are termed a subsequence or a pattern.

Proteins are one type of molecules that are tightly packed having packing densities that are comparable to that of crystalline solids. Yet there are numerous packing defects in the form of pockets and voids in protein structures, whose size distributions are broad. In a recent study, the volume v and area a of proteins were found not to scale as v∝a^{3/2}, which would be expected for tight-packing models. Rather, v and a scale linearly with each other (Liang and Dill, “Are Proteins Well-Packed?” Biophys. J. (2001); 81:751-766). This and other scaling studies of protein geometric parameters indicate that the interior of proteins is more like Swiss cheese with many holes in contrast with tightly packed jigsaw puzzles. In this regard, surface motifs of interest may include pockets, voids and other concave structures.

As used herein, a pocket is concavity on a protein surface into which solvent can gain access, that is, these concavities have mouth openings connecting their interiors with the outside bulk solution. Preferably, a pocket has an opening or mouth that is smaller than the largest interior diameter of the concavity as described in Edelsbrunner et al., “On the Definition and the Construction of Pockets in Macromolecules.” Disc. Appl. Math. (1998) 88:83-102 and incorporated herein by reference in its entirety. Other criteria may be used to define the structural features of a pocket, including minimum or maximum diameters, minimum and maximum volumes, ratios (minimum, maximum, or a range) of mouth diameters to interior diameters, ratios of pocket depths to diameter (interior or mouth diameters) as well as other criteria. A void, on the other hand, is an interior unoccupied space that is not accessible to the solvent. It has no mouth openings to the outside bulk solution. Further criteria may be used to characterize or limit the type of pockets and voids, such as voids or pockets large enough to contain at least one of a particular atom or molecule, for example, a water molecule.

Using the criterion that a void or pocket needs to be large enough to contain at least one water molecule, a database that contains 910,379 voids and pockets from 12,177 protein three-dimensional structures from the Protein Data Bank or PDB (Bernstein et al., “The Protein Data Bank: A Computer-Based Archival File for Macromolecular Structures.” J. Mol. Biol. (1977); 112:535-542) can be generated. Such a database can be found in the Computed Atlas of Surface Topography of Proteins (CASTp) at the University of Illinois at Chicago Bioengineering Department (available using the http protocol at the URL cast.engr.uic.edu).

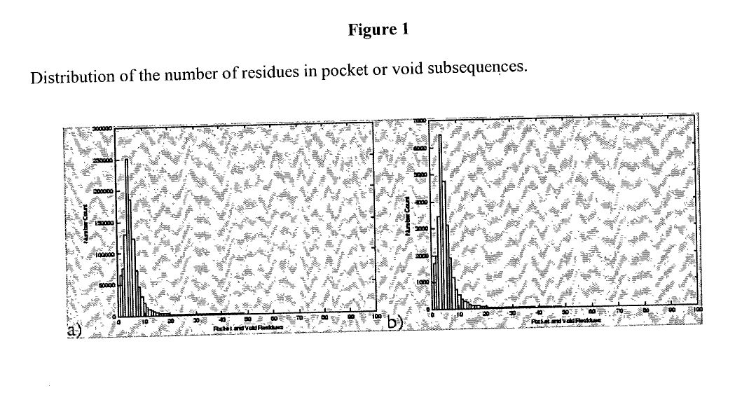

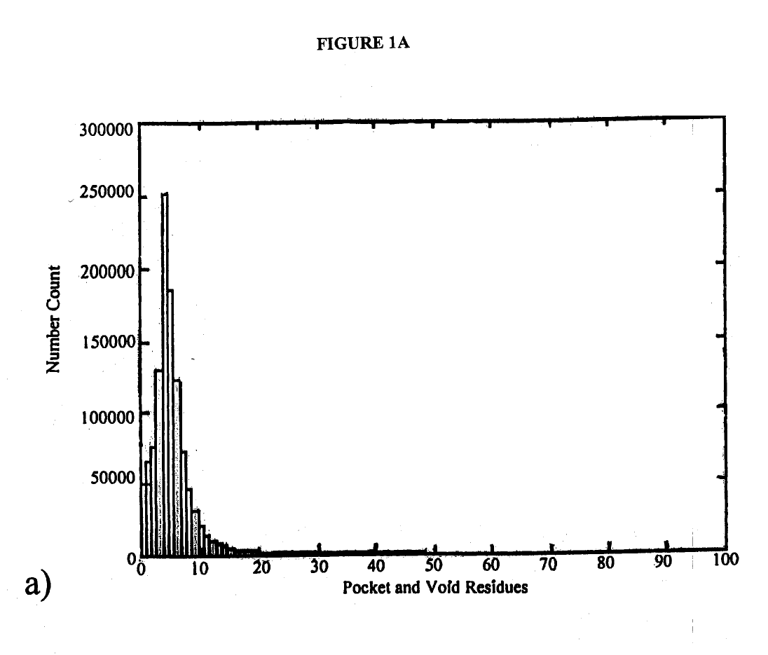

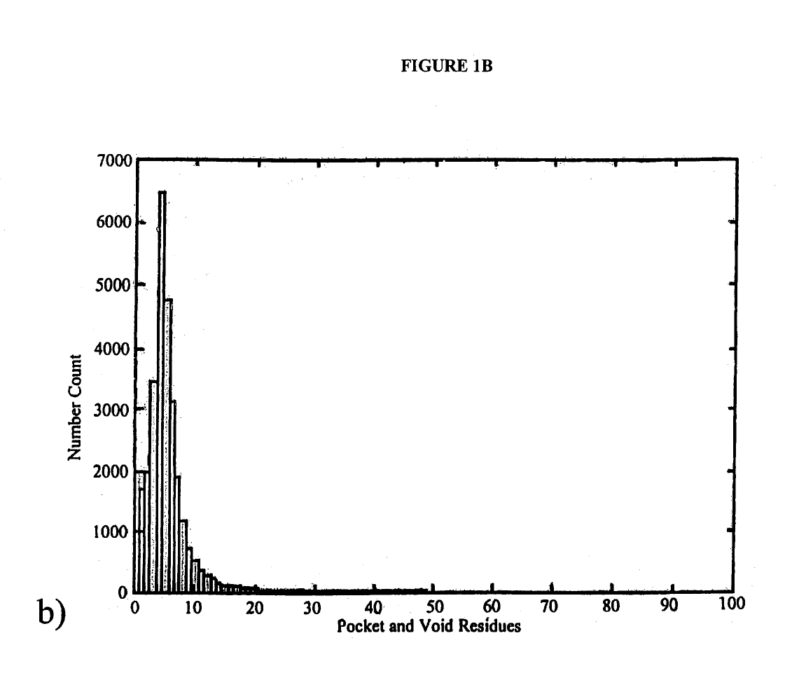

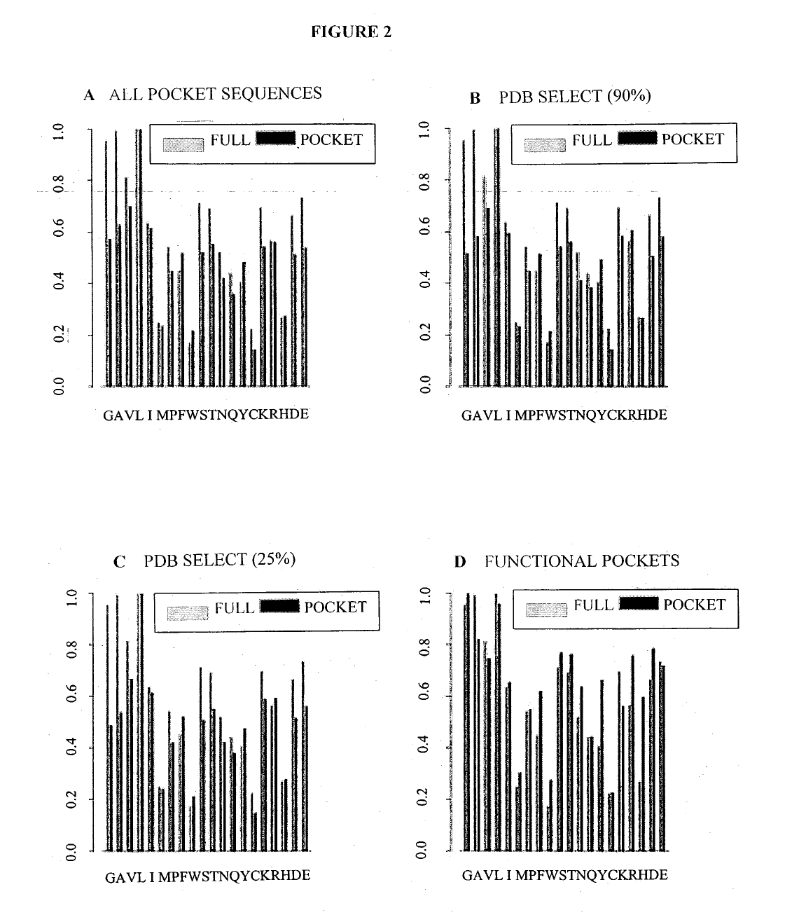

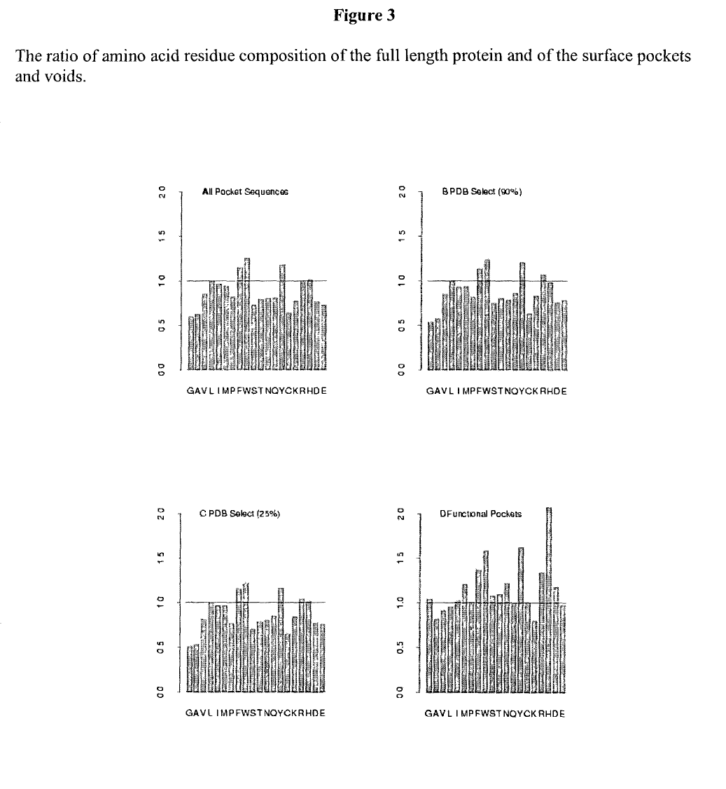

On average, there are 15 voids or pockets for every 100 residues (Liang and Dill., “Are Proteins Well-Packed?” Biophys. J. (2001); 81:751-766). The majority of pocket and voids have between 4 and 20 residues as shown in FIG. 1. Furthermore, the percent fractional composition of the pockets and voids is different from that of the full-length primary sequences. This compositional bias is illustrated in FIG. 2 which shows the composition of pocket patterns and the full primary sequences for all of the structures in the Protein Data Bank as well as for a subset of structures with sequence identities of 90 percent and 25 percent. FIG. 2d also shows the pocket composition for a subset of structures whose corresponding SwissProt (available using the http protocol at the URL www.ebi.ac.uk/swissprot/) entries contain clear functional annotation. For the set of pocket patterns containing functional residues annotated by SwissProt, aromatic residues W, Y and F, and residue R and H are favored, whereas residues A and K are disfavored (see FIG. 3).

The following is a discussion of detecting similar spatial patterns of surface motifs of one type of molecule—proteins. One skilled in the art would recognize that similar procedures could be applied to other types of molecules.

Calculation of Pockets and Voids

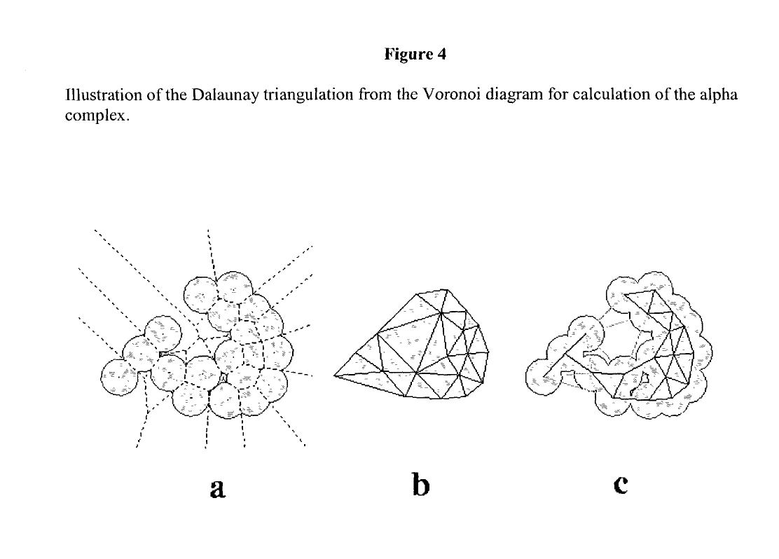

Procedures for identifying and measuring of protein pockets and voids are well known to one skilled in the art and are described in Liang et al., “Analytic Shape Computation of Macromolecules: II. Inaccessible Cavities in Proteins.” Proteins (1998); 33:18-29 as well as Liang et al., “Analytical Shape Computation of Macromolecules: I. Molecular Area and Volume Through Alpha Shape.” Proteins: Structure, Function, and Genetics (1998) 33:1-17; Liang et al., “Anatomy of Protein Pockets and Cavities: Measurement of Binding Site Geometry and Implications for Ligand Design.” Protein Sci. (1998); 7(9):1884-97; Edelsbrunner, “The Union of Balls and its Dual Shape.” Discrete Comput. Geom. (1995); 13:415-440; Edelsbrunner et al., “On the Definition and the Construction of Pockets in Macromolecules.” Disc. Appl. Math. (1998) 88:83-102; and in U.S. Pat. No. 6,182,016; all these references are incorporated by reference in their entirety. The key steps in these references are summarized here. Briefly, the procedure involves carrying out a Delaunay triangulation, alpha shape determination and discrete flow calculations as described by Edelsbrunner and Mucke, “Three-dimensional Alpha Shapes.” ACM Trans. Graphics (1994) 13:43-72; Edelsbrunner, “The Union of Balls and its Dual Shape.” Discrete Comput. Geom. (1995) 13:415-440; Facello, “Implementation of a Randomized Algorihtm for Delaunay and Regular Triangulations in Three Dimensions.” Computer Aided Geometric Design (1995) 12:349-370; Edelsbrunner and Shah, “Incremental Topological Flipping Works for Regular Triangulations.” Algorithmica (1996) 15:223-241; and Edelsbrunner et al., “On the Definition and the Construction of Pockets in Macromolecules.” Disc. Appl. Math. (1998) 88:83-102; all of these references are incorporated by references in their entirety. FIG. 4 shows how a Delaunay triangulation is done for a set of atoms in a highly simplified hypothetical, two-dimensional molecular model formed by atom disks of equal radius (FIG. 4a). If lines are drawn to connect each atom center to the next around the entire collection of atom centers, a polygon is obtained whose shape defined by the outer edges encloses all atom centers as shown in FIG. 4b. This polygon can be triangulated, in other words tessellated, with triangles so that there is neither a missing piece, nor overlap, of the triangles. Triangulation of the polygon is also shown in FIG. 4b, where triangles tile all of the shaded polygon area.

This particular triangulation, called the Delaunay triangulation, is especially useful because it is mathematically equivalent to another geometric construct, the Voronoi diagram shown by the pattern of dashed lines in FIG. 4a. The Voronoi diagram is formed by a collection of Voronoi cells. For the hypothetical model in FIG. 4a, the Voronoi cells include the convex polygon bounded all around by dashed lines, as well as the polygons with edges defined by dashed lines extending to infinity. Each cell contains one atom, and those extending to infinity contain boundary atoms of the polygon. A Voronoi cell consists of the space around one atom so that the distance of every spatial point in the cell to its atom is less than or equal to the distance to any other atom of the molecule. The Delaunay triangulation can be mapped from the Voronoi diagram directly. Across every Voronoi edge separating two neighboring Voronoi cells, a line segment connecting the corresponding two atom centers is placed. For every Voronoi vertex where three Voronoi cells intersect, a triangle whose vertices are the three atom centers is placed. In this way, the full Delaunay triangulation is obtained by mapping from the Voronoi diagram. That is, both the Delaunay triangulation and the Voronoi diagram contain equivalent information.

To obtain the alpha shape, or a dual complex, the mapping process is repeated, except that the Voronoi edges and vertices completely outside the molecule are omitted. FIG. 4c shows the dual complex for the 2-D molecule in FIG. 1a. The edges of the Delaunay triangulation corresponding to the omitted Voronoi edges are the dotted edges in FIG. 4c; a triangle with one or more dotted edges is designated an “empty” triangle (though not all empty triangles have dotted edges). The dual complex and the Delaunay triangulation are two key constructs that are rich in geometric information; from them the area and volume of the molecule, and of the interior inaccessible cavities, can be measured. As an example, a void at the bottom center in the dual complex (FIG. 4c) is easily identified as a collection of empty triangles (3 in this case) for which the enclosing polygon has solid edges. There is a one-to-one correspondence between such a void in the dual complex, and an inaccessible cavity in the molecule. The actual size of the molecular cavity can be obtained by subtracting from the sum of the areas of the triangles, the fractions of the atom disks contained within the triangle. Details for computing cavity area and volume are known in the art and are described in Edelsbrunner et al, “Measuring proteins and voids in proteins.” In: Proc. 28th Ann. Hawaii Int'l Conf. System Sciences. Los Alamitos, Calif.: IEEE Computer Society Press. pp. 256-264 (1995) and in Liang et al., “Analytical Shape Computation of Macromolecules: I. Molecular Area and Volume Through Alpha Shape.” Proteins: Structure, Function, and Genetics 33:1-17 (1998); both references are incorporated by references in their entirety.

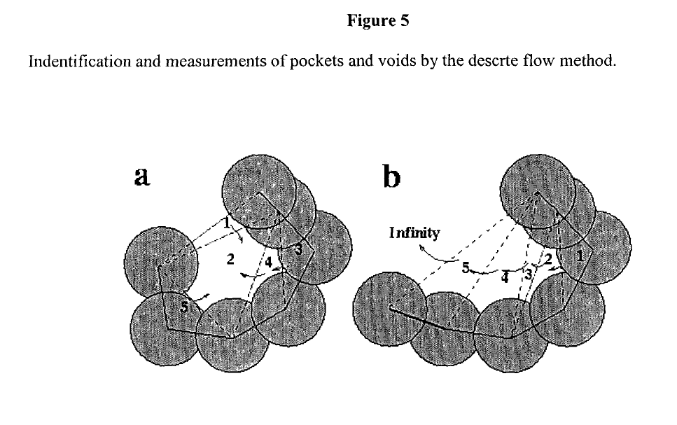

For identifying and measuring pockets, the discrete flow method may be employed as described in Edelsbrunner 1995, “The union of balls and its dual shape.” Discrete Comput. Geom. 13:415-440 and in Edelsbrunner et al., “On the Definition and the Construction of Pockets in Macromolecules.” Disc. Appl. Math. (1998) 88:83-102; both references are incorporated herein by reference in their entirety. For the 2-D model of FIG. 4, discrete flow is defined only for empty triangles, that is, those Delaunay triangles that are not part of the dual complex. An obtuse empty triangle “flows” to its neighboring triangle, whereas an acute empty triangle is a sink that collects flow from neighboring empty triangles. FIG. 5a shows a pocket formed by five empty Delaunay triangles. Obtuse triangles 1, 4, and 5 flow to the sink, triangle 2. Triangle 3 is also obtuse; it flows to triangle 4, and continues to flow to triangle 2. All flows are stored, and empty triangles are later merged when they share dotted edges (dual, non-complex edges). Ultimately, the pocket is delineated as a collection of empty triangles. The actual size of the molecular pocket is computed by subtracting the fractions of atom disks contained within each empty triangle. The 2-D mouth is the dotted edge on the boundary of the pocket (upper edge of triangle 1, in this case), minus the two radii of the atoms connected by the edge. The type of surface depression not identified as a pocket is illustrated in FIG. 5b; it is one formed by five obtuse triangles that flow sequentially from 1 to 5 to the outside, or infinity.

All the features of the 2-D description have more complex 3-D counterparts. The convex polygon in three dimensions is a convex polytope instead of a polygon, and its Delaunay triangulation is a tessellation of the polytope with tetrahedra. When atoms have different radii, the weighted Delaunay triangulation is required, and the corresponding weighted Voronoi cells are also different.

An example of computed pockets and voids of each protein structure in the Protein Data Bank are conveniently organized as the database of Computed Atlas of Surface Topography of Proteins or CASTp, also available using the http protocol at the URL cast.engr.uic.edu.

Patterns of Surface Residues of Pockets and Voids

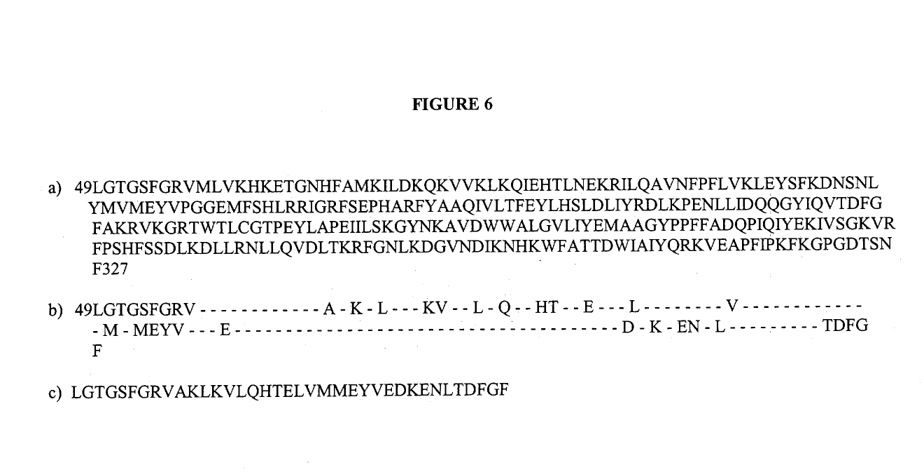

Protein spatial patterns of the surface motifs are derived from the residues forming the walls of both pockets and voids as shown in FIG. 6. These residues are termed the surface residues. The spatial patterns are formed by concatenating the surface residues and arranging in order of the position in the primary sequence. A pattern is also called a subsequence. The terms spatial sequence pattern, spatial pattern, surface pattern, subsequence, sequence pattern or pattern refer to the same thing and are used interchangeably. There are other ways in which subsequences can be formed, for example, by concatenating only a subset of the surface residues. The subsequences can be used to assess the similarity relationship of protein surfaces. For example, the catalytic subunit of cAMP dependent protein kinase (1cdk) and tyrosine protein kinase c-src (2src) are both kinases and bind to AMP related molecules. The overall sequence identity between them is 16 percent. However, their AMP binding sites have similar shape and chemical texture as identified by the alpha shape method. In both cases, the residues participating in the formation of pocket walls come from diverse regions in the primary sequences. However, when these residues are concatenated, the shorter subsequences of binding site residues have a much higher sequence identity of 51 percent. This approach can be applied in general to any two surface patterns of pockets or voids.

The methods described herein involve generating of a database that preferably contains the surface pockets and interior void subsequences of the relevant molecular sequences. In one embodiment for use in identifying patterns of surface residues, the protein structures publicly available in the Protein Data Bank may be used. Similarly, in this embodiment the subsequence is generated from the residues forming the wall of the pockets or internal voids. By concatenating wall residues on the same polypeptide chain, a subsequence is compiled for each protein pocket or void. The residues of the subsequence so concatenated form a short amino acid residue sequence fragment. This subsequence ignores all intervening residues that are not on the wall of the pocket or void. The order in which the subsequence is concatenated can be according to the numbering in the primary sequence, for example, from lower to higher as shown in FIG. 3. However, any form of concatenation can be used as well as any random arrangement of the residues in the subsequence. Combining subsequences of all the 910,379 pocket and void subsequences from 12,177 structures from the Protein Data Bank, a new database of Pocket and Void Sequence of Amino Acid Residues (pvSOAR) is generated. The pvSOAR database may be continually updated by including the subsequences of pockets and voids calculated from the three-dimensional coordinates of the newly solved structures from the Protein Data Bank. Thus, as more three-dimensional structures of proteins are added to the Protein Data Bank, the number of subsequences in pvSOAR database also increases.

Functional Surfaces

The pvSOAR database is only one of many possible databases that can be derived for use with the methods described herein. Other databases may be created by identifying subsequences of functional surfaces consisting of residues of interest from the primary protein sequence. The residues are extracted and concatenated.

In one embodiment for creating functionally important subsequences, residues that are spatially located to participate in hydrogen bonding or make hydrophobic contacts with a substrate can be used. Other embodiments would use the following functional residues to form subsequences: those identified that bind a particular small molecule compound or drug, those comprising a catalytic triad ligand binding residues, those interacting with a specific ligand such as, but not limited to, ATP, GTP or a metal atom. Another embodiment encompasses methods that are sequence order independent and can analyze subsequences derived from residues of multiple chains. The methods can also be applied to look at protein-protein interactions of flat surfaces using surface patterns generated by means in addition to geometry.

Other ways that a database of subsequences, for example, pockets and voids, can be generated is by identifying the n^{th} residue in a pocket, for example, first or last N-terminal amino acids, selected amino acids, for example, every fifth or every other one, etc., amino acids involved in ligand binding, amino acids in random coils, amino acids from multiple sequence alignments, amino acids that interact with a drug, or random amino acids from a sequence. Thus, the database consists of subsequences derived from those amino acids that compose the pockets or voids or other structural features.

The various databases generated can be used alone or in combination to discover new information about a subsequence or a molecule. A query subsequence can be formulated in a number of ways as described above, and can be searched against pvSOAR or against another database so that information can be inferred based on the nature of the database. For example, assume there are two databases: A is a database of drug-binding contact subsequences and B is a database of protein pocket and void subsequences (pvSOAR). The query subsequence that is a drug-binding contact subsequence can be used to searched against database A and B. While it might be expected to find a match in database A, it might be the case that none is found. No significant matches found in a search against database A could suggest that the drug binding site for the query is not similar to other known drug-binding sites. A significant match against a subsequence from database B could potentially be a new alternative binding site for the drug, thereby yielding valuable information about potential drug side effects to researchers. In terms of drug development, if a group of people lack a protein that is acted upon by a drug, another protein could be identified as a target for the same drug.

Thus, as can be seen, one may search a query subsequence against each different database and the information obtained is complementary and additive. This information can then be used to design experiments to confirm the search results. The information provides guidance, so for example, one can design a drug with properties based on the search and not even consider designing other drugs because the search information indicates that these other drugs have a low probability to bind or modify the properties of the protein.

Surface Comparison Metrics

1. Surface Motif Subsequence Comparisons. A characteristic of some of the algorithms is the use of a scoring matrix. The formulation of scoring matrices is well known to one skilled in the art, see for example Whelan and Goldman, “A General Empirical Model of Protein Evolution Derived from Multiple Protein Families Using a Maximum-Likelihood Approach” Mol. Biol. Evol. (2001) 18(5):691-699 and Henikoff and Henikoff, “Amino acid substitution matrices from protein blocks.” Proc. Natl. Acad. Sci. USA (1992) 89:10915-10919; both of which are incorporated by reference in their entirety. The scoring matrix is formulated in such a way that a similarity score is given to each pair-wise combination of elements (molecules, residues, etc.) found within the subsequences under consideration. The magnitudes of the individual similarity scores are arbitrary numbers determined by various methods. When a query subsequence is aligned and compared to a subsequence in the database, each matched pair of elements will have a score. For example, a simple scoring matrix can assign a number xₗ for each residue pair in the aligned sequences for the particular alignment under consideration. The comparison metric is then computed by the algorithm as the sum of xₗ over i for all element pairs.

Other scoring matrices that can be used may assign a penalty for gaps that are inserted in the subsequences to achieve matching. The penalty can be any arbitrary number, usually negative, determined by the scoring matrix and the magnitude of the penalty can be modified according to the degree of matching that is desired. Thus, the comparison metric is the sum of the penalty and the score given to each matched residue. One of ordinary skill in the art would recognize that a scoring matrix can be formulated to any specification.

The method preferably involves comparing a query subsequence against the subsequences in a database using dynamic programming. Any algorithm for comparing the subsequences can be used. The result of each comparison is a measure of the similarity based on various criteria particular to the comparison algorithm. The similarity measures are generally referred to herein as a comparison metric. One form of the comparison process aligns the subsequences for matching each residue in the query sequence with the same residue type in the database subsequences. This may be termed exact matching. Other comparison techniques can involve matching amino acids that have similar properties such as aromaticity, charge, polarity, hydrophobicity, hydrophilicity, small or large side chain or any property that is desired. Indeed, numerous algorithms, techniques, and heuristics from the field of non-linear programming known to those of skill in the art may be used or adapted for use to compare the subsequences.

The sequence alignment using the pvSOAR database is a sequence alignment of structural pocket comparison method that identifies residues that are conserved between two geometrically defined pockets or voids from protein structures. This subset of pocket residues is used to measure the similarity in the three-dimensional structures. Both identical and biologically significant residue matches are considered.

2. Histogram Signature. The pvSoar database can also be searched using a sequence order independent method. Residues belonging to a particular pocket or void are identified and extracted as described above. The residues are then sorted alphanumerically and counted by type. The result is a signature composition distribution for the given pocket. This process is repeated for every pocket and void in the pvSoar database to create a new database of pocket and void signature of amino acid residue distributions (pvSoarD). The signature composition distributions can be compared to each other in any number of ways to generate a comparison metric. One suitable technique is to use a measure of their relative entropy as a comparison measure. For two distributions U and R the relative entropy is defined as:

$$H ( U \vert \vert R ) = {\sum }_{i} U ( {x}_{i} ) log ( \frac{U ( {x}_{i} )}{R ( {x}_{i} )} ) \cdot$$

Comparing pockets and voids using a sequence independent method allows the identification of similarities in more complex surfaces such as protein-protein interfaces or pockets comprised of residues from multiple chains.

3. Pocket and Void Residue Substitution Matrix. Another type of scoring matrix is modeled from the method of Whelan and Goldman “A General Empirical Model of Protein Evolution Derived from Multiple Protein Families Using a Maximum-Likelihood Approach” Mol. Biol. Evol. (2001) 18(5):691-699 and incorporated herein by reference in its entirety, to create an accurate description of amino acid replacement for the pvSOAR database. Assuming all amino acid sites in an alignment evolve independently and are reversible, a substitution matrix can be constructed. First, all the proteins that have contributed subsequences to the pvSOAR database are separated into families. Multiple sequence alignments are performed on pocket sequences from grouped families. A phylogenetic tree is built for each family based on the sequence alignments. Phylogenetic analysis of the protein sequences for each family is done using maximum likelihood. Using a continuous-time Markov model, the likelihood function for each protein sequence is written out, and parameters of mutation rates of individual amino acids residues on protein functional surfaces are adjusted so the data likelihood of observing these sequences is maximized.

The result is a 20 by 20 matrix where each element is the instant rate of change between a pair of residues. Note that each pair actually has two entries because the direction of the change may have a different rate or probability. That is, a change from A to B may not be equally likely as a change from B to A. This process is repeated for each protein family. The individual matrices may be used for scoring a query sequence against the members of the corresponding family to generate the comparison metrics. Alternatively, statistical analysis is performed between elements of the matrices for all families resulting in a single matrix, representing the overall rate of substitution of amino acid residues. A single matrix is then used for generating the comparison metrics. Different matrices can be created based on different analysis. For example, the mean values of the corresponding elements of the matrices may be used (e.g., for the A-G matrix element, the mean of A substituting for G across all families may be used) or the minimum values may be used (e.g., for the A-G element, the minimum of A substituting for G across all families). The rate values are converted to probability values that a given residue is substituted for another.

4. Surface Motif Structural Comparison. Comparison metrics may also be obtained from geometrical comparisons. The residues comprising subsequences as described above have inherent information in their 3-D structures that can be alternatively or additively used to compare surfaces. In one embodiment the residues forming the walls of pockets and voids are extracted to form a substructure. In this case, the structure would be comprised of the exact residues that make up the pvSOAR subsequence for a pocket or void. Another way to describe it would be to map the residues of the subsequence to their 3-D coordinates to form substructures.

In some cases, only a subset of the atoms from a residue is participating in substrate binding or located on the wall of pockets. To account for this, an average pocket residue is constructed from the set of atoms of a unique residue. The mean x, y, and z coordinates of these atoms are assigned to that residue, resulting in a many-to-one correspondence between atoms and residues.

RMSD

The optimal structural alignment between the average residue atoms is calculated after implementing the method as described in Umeyama (“Least-Squares Estimation of Transformation Parameters Between Two Point Patterns,” IEEE Trans. Pattern Anal. Machine Intell., PAMI (1991) 13(4); 376-380) which is incorporated herein by reference in its entirety. This method calculates the least squares estimation for transformation parameters through singular value decomposition. The transformation gives the root mean square distance between two structures of equal atoms.

Pocket Sphere RMSD

The RMSD comparison metric is useful for structures that are highly similar, but may be sensitive to outliers dominating the RMSD value and to the number and nature of structures fitted. The RMSD metric can also be shown to present ambiguous similarities between proteins, that is, structures having the same distance yet different structures. In one embodiment, these drawbacks are decreased by adapting the method of the unit-vector RMS (URMS) to protein pockets and voids as described in Chew et al. (“Fast Detection of Common Geometric Substructure in Proteins.” J. Computational Biol. (1999) 6) and incorporated herein by reference in its entirety. To determine a URMS comparison metric, the average residue atoms are first transformed around the center of mass of the pocket. Each atom is then transposed onto the unit sphere from their normalized N_{xyz} coordinates using the relationship

$$\begin{matrix}{N}_{xyz} = \sqrt{{( x - {x}^{–} )}^{2} + {( y - {y}^{–} )}^{2} + {( z - {z}^{–} )}^{2}} \\ \{ X , Y , {Z}_{sphere} \} = \{ \frac{x - {x}^{–}}{{N}_{xyz}} , \frac{y - {y}^{–}}{{N}_{xyz}} , \frac{z - {z}^{–}}{{N}_{xyz}} \}\end{matrix}$$

The resulting structure is a collection of unit vectors comprising a sphere that retains the original orientation of atoms in the structure. The substructure is dubbed the pocket sphere for the case where the substructure is a sphere. The standard RMSD calculation is then performed on the pocket sphere.

5. Combinatorial Search. While the overall size of pockets and voids may vary greatly, the conservation of key functional residues may exist. To test for this possibility a combinatorial search for patterns of N pocket residues may be performed. For example, a pocket of size 100 residues contains a catalytic triad of residues. Considering only 3 of the 100 residues are functionally interesting, we would be interested in searching for similar combinations of 3 residues in other pockets. Searching for a similar surface to the catalytic triad of residues would involve searching all combinations of three residues in a given pocket.

A combinatorial search for a given set of residues identified by methods described in the section Surface Motfis in Molecules is performed to identify similar surfaces in proteins. The search space can be reduced by using only identical residues or residues sharing biochemical properties.

Statistical Analysis of the Comparison Metrics

The statistical significance of the comparison metrics obtained by aligning the query subsequence with the subsequences in the database is analyzed. Assessment of statistical significance of matched pocket subsequences is very challenging since unlike alignment of the complete primary sequence, which has hundreds of residues, the majority of pocket patterns subsequences have between 5 and 20 amino acid residues (see FIG. 1). Secondly, the amino acid composition of the pocket subsequences is biased as explained above and is different from that of the full chain sequences. Thirdly, two pocket subsequence patterns frequently have different number of residues, so that the introduction of gaps in the alignment is necessary to maximize matching the subsequences. Although recent theoretical work has obtained analytical results for local alignments with gaps using selected scoring systems, no exact theoretical models are known for local sequence alignment of very short sequences with gaps. As an example, FIG. 6a shows that the distribution of Smith-Waterman similarity scores for the zinc binding pocket in hydrolase (PDB id=1c7k, chain=A) is very different from a theoretical extreme value distribution model.

Statistical analysis generally involves performing distributional verification, followed by significance testing. Specifically, each comparison metric can be analyzed according to a statistical model that explains the characteristics of the distribution of the comparison metrics to ensure the data set is valid. Then, the metrics are analyzed to determine their probabilistic significance. In some cases, a randomized distribution is generated, and the mean and variance are determined to aid in the analysis of the statistical significance of the comparison metrics. In other cases, the mean and standard deviation can be obtained from the observed non-randomized distribution of the comparison metrics. The statistical significance of the comparison metrics generally involves measuring the probability of obtaining the same or a greater comparison metric for each particular comparison metric.

1. Distribution Verification

The evaluation of the statistical significance preferably includes verifying that the distribution of comparison metrics conforms to an expected or assumed underlying probability distribution. For example, and without limitation, an extreme value distribution (EVD) model is preferably used. A standard extreme value distribution has the parametric form of

$$f ( S ) = exp ( - {ⅇ}^{\frac{S - a}{b}} ) \cdot$$

The mean μ and standard deviation σ of the EVD are related to the parameters a and b by the following relationships:

μ=a−bΓ′ (1)

where Γ (1) is the Euler's constant and is equal to 0.5772, and

σ²=b²π²/6

In certain scenarios, other distributions such as a Gaussian distribution may be found to accurately characterize the comparison metrics. The confirmation that the correct distribution model is used may be assessed by any suitable statistical test such as, but not limited to, Anderson-Darling statistics, Kolmogorov-Smirnov statistics or Kuiper Statistics.

In one preferred embodiment, the alignment of a query subsequence with the subsequences in the pvSOAR is carried out by applying the Smith-Waterman algorithm as described in Smith and Waterman, “Identification of Common Molecular Subsequences.” J. Mol. Biol. (1981), 147, 195-197 and as implemented in SSEARCH by Pearson as described in Pearson, “Empirical Statistical Estimates for Sequence Similarity Searches.” J. Mol. Biol. (1998) 276: 71-84 to compare the similarity of two pocket pattern subsequences. Both of these references are incorporated herein by reference in their entirety. In this embodiment, BLOSUM50 is used as a default scoring matrix. Detail descriptions of SSEARCH and BLOSUM50 are known to one skilled in the pertinent the art (Pearson, “Empirical Statistical Estimates for Sequence Similarity Searches.” J. Mol. Biol. (1998) 276:71-84). Another embodiment utilized the scoring matrix describe in Pocket and Void Residue Substitution Matrix.

The Smith-Waterman algorithm returns a score for each pair of subsequences. Since there are 910,379 subsequences in the pvSOAR database, the first set of scores returned by the Smith-Waterman alignment would be a total of 910,379 scores. The score of a matched pair could the same as that of one or more other matched pair of subsequences. Thus, a frequency curve can be generated that illustrate the distribution of scores over the entire database as shown in FIG. 6.

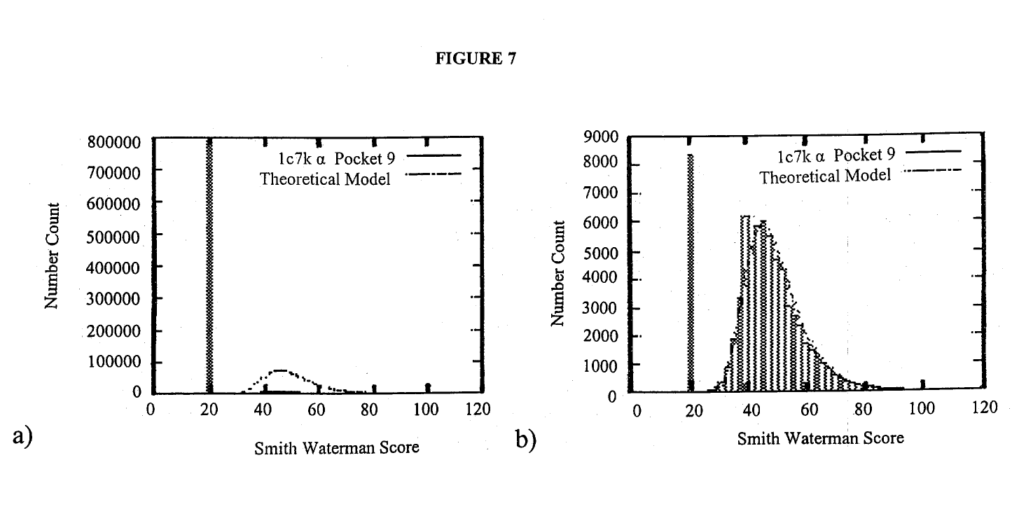

The statistical significance testing of the comparison metrics may also include correction of the comparison metrics to exclude matches with scores less than a threshold value. Specifically, it was discovered that if the large peak in the histogram of random alignment similarity scores of FIG. 6a is removed, the remaining scores frequently follow an extreme value distribution model. In one example, a query subsequence of a surface pocket is first searched against all pocket subsequences in the pvSOAR database that contains Nₐₗₗ=910,379 pocket subsequences. Pocket subsequence matches from this search that have Smith-Waterman similarity scores below 20, Nₜ, are removed so that N pocket subsequences remain with Smith-Waterman similarity scores higher than 20. The pocket subsequences removed correspond to the sharp peak in FIG. 7a, which typically contain alignments of only 1 or 2 residues.

2. Significance Testing

The statistical significance of the comparison metrics generally involves measuring the probability of random chance in obtaining the same or a greater comparison metric for each particular comparison metric. To do so, the underlying distributional parameters need to be evaluated.

Because the distributions of the comparison metrics may be biased due to the nature of the database (since it typically already contains molecular sequences of interest), the mean and standard deviation of the observed metrics may also be biased. Thus, to determine the statistical significance of the comparison metrics for a given query subsequence, that subsequence is compared to a randomized subsequence database to generate random comparison metrics. The random comparison metrics are then analyzed to determine the mean μ and standard deviation σ of the random set. Then, using the derived random distribution characteristics, the original comparison metrics may be analyzed to determine the probability of achieving those metrics. In this way, high valued comparison metrics may be deemed significant if it is unlikely to achieve such a score randomly.

In this regard, the EVD distribution is simplified when a z-score is used of the form

z=(S−μ)/σ,

is used, where S is the comparison metric under consideration and the mean μ and standard deviation σ correspond to the mean and standard deviation of the random comparison metrics. The EVD distribution simplifies to:

exp(−e^{zπ/\sqrt{6}-Γ′(1)})=1−exp(−e^{1.282z-05772})

A. Verification of Sequence Matching

To show that sequence matches are statistically significant, the distribution of the observed comparison metrics are compared to a random distribution of comparison metrics. This is done as follows. To generate the random comparison metrics, 200,000 pocket subsequences from the set of N pocket subsequences (or all of subsequences if N is less than 200,000) are selected. The residues in the subsequences are shuffled to get a random order to generate a random database. The query subsequence is compared (e.g., via a Smith-Waterman similarity scores) against this shuffled database to generate comparison metrics having a distribution due to random matching of the query subsequence against the subsequences in the randomized database. This random distribution of similarity scores may be fitted to an EVD distribution. As with the authentic (nonrandom metrics), the random comparison metrics below a threshold value may be excluded to improve the fit (thereby providing a more accurate measurement of the mean μ and standard deviation σ); the fitting of the random distribution is not limited to using the EVD distribution model; a determination of goodness of fit may be performed using the Kolmogorov-Smirnov test.

A goodness-of-fit test of the similarity scores obtained from the shuffled database to a theoretical EVD distribution is evaluated using the Kolmogorov-Smirnov test as is provided in SSEARCH. FIG. 7b shows a truncated distribution of the N subsequences after removing the low score matches (Nₜ). The overlaying continuous line in FIG. 7b is the calculated theoretical EVD distribution.

The significance level of the comparison metric of each match is then estimated. Typically, the significance level is analyzed only if the Kolmogorov-Smirnov statistic as defined by the D-statistics is less than 0.1, indicating that the random scores are not inconsistent with an EVD distribution. To do this, the mean and the standard deviation are calculated from distribution of scores from the randomized database and then used to estimate the p-value. The p-value represents the probability of obtaining the same or better score Z>z by chance, where z is the expected comparison metric when searching the query pattern against pvSOAR database. It is calculated from

z=(S−μ)/σ

where S is the comparison metric obtained from the unshuffled database of N subsequences, μ is the mean of random comparison metrics, and σ the standard deviation of the random distribution. For the extreme value distribution, the p-value can be estimated from the z score of the match as follows from the EVD distribution:

$$\begin{matrix}p ( Z > z ) = 1 - exp ( - {ⅇ}^{z π / \sqrt{6} - {Γ}^{′} ( 1 )} ) \\ = 1 - exp ( - {ⅇ}^{- 1 \text{.} 282 z - 0.5772} )\end{matrix}$$

where Γ′(1) is 0.5772. The E-value can then be calculated from the p-value as follows

E=p˜(Nₐₗₗ−Nₜ)

where Nₐₗₗ−Nₜ is also equal to N, which is the number of comparisons under consideration after excluding Nₜ comparisons as being inconsistent with the distribution model (e.g., EVD). The E-value represents the expected number of random pocket sequences having the same or better score that would be expected by chance. The estimated E-value is used to exclude matches that have no statistical significance.

Since the random model for estimating E-values assumes that each residue appearing in a pocket subsequence comes from a random position in the primary sequence, the residues in a matched surface pattern subsequence should not be sequence neighbors in the full length primary sequence. This requirement is satisfied by using a sequence separation measurement, dₛ, which is calculated as follows

$${ⅆ}_{s} = \frac{{\sum }_{i {εP}_{r}} n ( i ) - n ( i - 1 )}{{N}_{r} - 1}$$

where Pᵣ is the set of matched pocket residues in the subsequence with a total of Nᵣ residues, i is the ith matched pocket residue in the subsequence after ordering by the sequence number n(i) while n(i−1) is the sequence number of the preceding residue. If dₛ<2 for aligned residues in a matched pocket subsequence, this match is excluded from analysis. To further ensure similar surface patterns are statistically significant, one may require that a matched surface pattern subsequence contain at least three residues.

B. Verification of Histogram-Based Metrics

The generation and use of a random database to obtain a random distribution of subsequences to show that subsequence matches are statistically significant, may not be required. For example, in one embodiment, the mean and standard deviation of the distribution of comparison metrics based on the histogram signature of the subsequences can be obtained directly from the distribution.

C. Verification of Geometric-Based Metrics

The statistical significance of the geometric comparison metrics obtained from scoring the matches according to their RMSD value between surface substructures may be calculated by the probability, p. The probability p is a measure of the probability of observing a given RMSD value from the estimated distributions of randomly generated pockets subsequences. The random pocket subsequences for evaluating the statistical significance of the RMSD values is generated by selecting two pocket subsequences are chosen at random from all available pocket subsequences and for each a specified number of atoms, Nₐₜₒₘₛ, are randomly selected. RMSD values are calculated for this subset of atoms against the query subsequences. Approximately 100,000 calculations are performed for various numbers of atoms, Nₐₜₒₘₛ (e.g., 3<Nₐₜₒₘₛ<100. The actual number calculation varies for each Nₐₜₒₘₛ due to the cases where the atoms from a random pocket are lesser than Nₐₜₒₘₛ. The result is a distribution of random RMSD values for each 3<Nₐₜₒₘₛ<100.

A z-score is calculated from the random pocket subsequence RMSD calculations aftering determining the mean and the standard deviation from a distribution with equivalent number of atoms. The p-value can be estimated from the z-score for the distribution by

p(Z>z)=1−exp(−z−exp(−z))

and the p-value is used to evaluate the significance for the pocket subsequnce match based on the RMSD value.

When the URMS distances values are used to generate comparison metrics, the statistical significance of the metrics may be determined in the same manner as when RMSD values are used for generating the comparison metrics. In this case however, the statistical significance of a pocket sphere RMSD value is calculated as was done for the original substructure. The process is repeated to create distributions for the pocket subsequence sphere with the additional step of converting pocket atoms to the pocket sphere before calculating the RMSD. The random generator was reset so that pocket sphere distributions were not derived from the same set as the full pocket distributions for Nₐₜₒₘₛ atoms. The p-value is used to evaluate the significance for the pocket sphere similarity.

Methodology

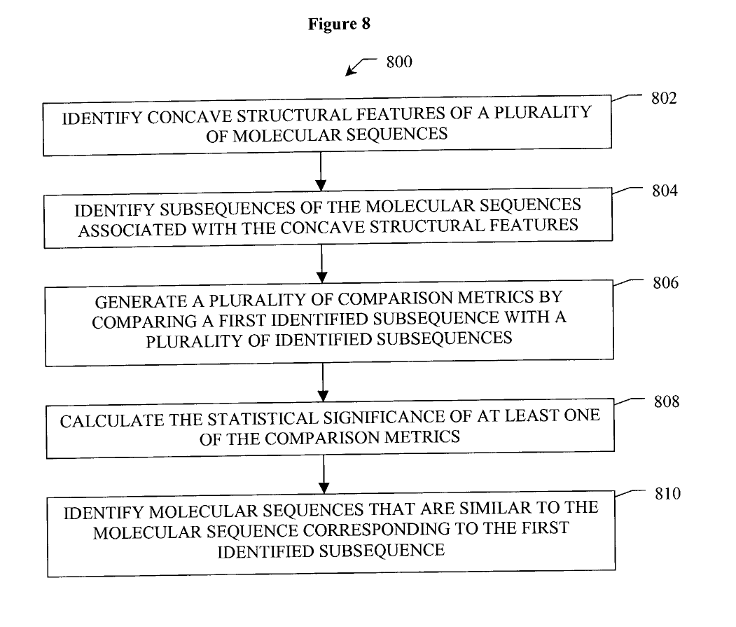

A preferred method 800 of identifying similar molecule sequences will now be described with reference to FIG. 8. At step 802, concave structural features of a plurality of molecular sequences are identified. The structural features may be pockets or voids or other concave features defined by suitable criteria. In a preferred embodiment, the molecular sequences are proteins and the subsequences are amino acids, or residues. The structural features may be identified using alpha shape computation or Delaunay triangulation.

At step 804, subsequences of the molecular sequences associated with the concave structural features are identified. The subsequences may be the elements that line the interior of the concavity, or be a subset thereof. Specifically, in the case of protein analysis, only residues that participate in binding one or more substrates or ligands might be used. In addition, the subsequences might correspond to active sites.

At step 806, a plurality of comparison metrics are generated. The comparison metrics are typically generated by comparing a one subsequence with a plurality of other subsequences, which typically reside in a suitable subsequence database. The comparison metrics may be calculated using signature composition distributions, distribution entropy, alignment algorithms such as the Smith-Waterman algorithm or equivalents, or by geometric measurements such as root-mean-square distances, including unit-vector-based RMS measurements.

At step 808, the statistical significance of at least one of the comparison metrics is evaluated. Typically, the highest scores are analyzed until the significance measures indicate the scores are no longer significant. The analysis may include various steps. That is, calculating the statistical significance of the comparison metrics may include analyzing the comparison metrics in relation to distribution parameters obtained from randomized comparison metrics. In one embodiment, a first subsequence may be compared with a plurality of random subsequences, and then the distribution parameters associated with the random comparison metrics may be determined. Then, the probability of randomly obtaining individual comparison metrics may be analyzed using the distribution parameters. This is referred to as a p-value. More particularly, the probability of randomly obtaining a given comparison metrics is performed using the following relationship:

$$p ( Z > {z}_{i} ) = 1 - exp ( {ⅇ}^{\frac{{z}_{i} π}{\sqrt{6}} - {Γ}^{′} ( 1 )} ) ,$$

wherein

zₗ=(Sₗ−μ)/σ

and wherein the distribution parameters are the mean, μ, and the standard deviation, σ, of the random comparison metrics, and the individual comparison metrics are given by Sₗ. The individual p-values may be multiplied by the number of metrics under consideration to provide an E-value.

Additional statistical testing may be performed, including verification that the comparison metrics conform to an expected distribution. Because the p-values and E-values are determined using the assumed distribution, it is desirable to confirm that the distributions in fact conform to that particular distribution model. Typically, the extreme value distribution is used as the assumed underlying distribution. Determining whether the comparison metrics are consistent with a predetermined distribution characteristic is preferably performed using the Kolmogorov-Smirnov goodness-of-fit test. The goodness of fit test is preferably performed on both the original comparison metrics as well as the randomized comparison metrics.

In many circumstances, it may be desirable to omit or exclude a subset of comparison metrics as not conforming to the assumed distribution. These comparison metrics are treated as noise or as otherwise insignificant. The measurements to exclude are typically identified as those that fall below a threshold value.

At step 810, molecular sequences that are similar to the molecular sequence corresponding to the first identified subsequence are identified. The identification is typically based on the statistical significance of the comparison metrics.

The methods are applicable to any molecule that consists of a collection of atoms or residues arranged in a sequence. For example, the methods are applicable to the analysis of similarities between DNA, RNA, proteins, polypeptides, and polysaccarides. These are only some examples of molecules that can be analyzed by the methods described herein. One skilled in the art would recognize that any biological molecule that is made up of a series of units is encompassed.

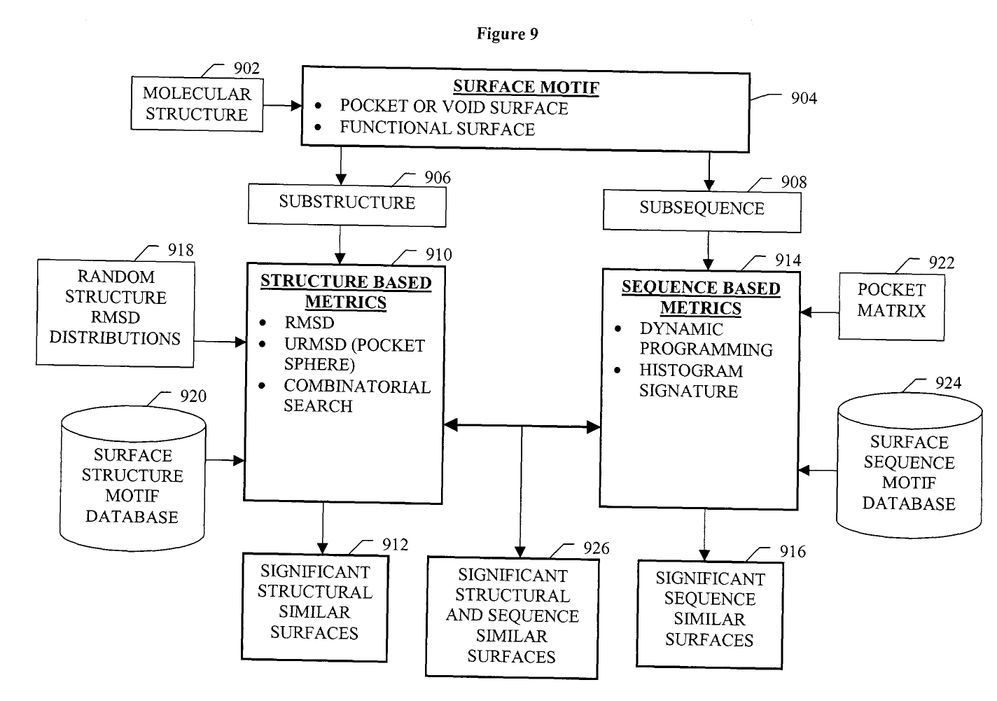

Additional preferred methods of identifying significantly similar surfaces will be described with respect to FIG. 9. Molecular structures 902 that are under investigation, which also referred to as query molecular structures, or in some embodiments, query proteins, are analyzed to identify a surface motif as shown in box 904. The surface motif identifies structural features (or elements of those features) of interest as described above. For protein molecules, the surface motif may consist of residues of interest in the protein. The motifs are extracted and concatenated to form a query subsequence 908. The 3-D coordinates of the motifs are extracted to form a query substructure 906.

The query subsequence 908 is then searched using comparison process 914 such as the Smith-Waterman algorithm or other sequence-based algorithm against a surface sequence motif database 924, preferably pvSOAR, or a database constructed using suitable criteria, as described above. A scoring matrix 922 may be utilized to generate the comparison metrics. A list of significant surfaces is returned from comparison process 914.

Alternatively, the query substructure 906 is searched using the RMSD, URMSD or other suitable geometric-based algorithm in comparison process 910 against a surface structure motif database 920. A list of significant surfaces is returned from comparison process 910.

The comparisons resulting in relatively high comparison metrics provide molecular structures likely having significant structural or sequence similarities 912, 916, respectively. Similarity is of course a relative trait, and thus the absolute measure of the comparison metrics are not necessarily important since it is the relative measure that may be used to identify similar molecules. Thus, the term “similar” is meant to refer to molecules corresponding to subsequences that have a confirmation in three dimensions. The preferred way of identifying similar molecules, as described herein, is to identify subsequences of structural motifs having the highest comparison metrics, typically metrics above a threshold value. Thus, if comparison metrics are converted to p-values or E-values, then values lower than the thresholds would be more similar. The threshold may be set in response to a number of factors discussed herein, including statistical significance testing (e.g., the threshold may be set based on the mean and/or standard deviation, such as one, two, three, or more standard deviations above the mean), the level of bias in the database sequences (more biased databases would invite the use of lower thresholds). The nature of the study may also affect what asutiable threshold will be. For example, in an evolutionary study where proteins of interest are more distantly related and are not likely to be the same family, superfamily, or fold, then lower thresholds (or higher E-values) might be more acceptable.

In this regard, the results are preferably analyzed in comparison processes 910, 914, to determine the statistical significance of the scores. Of course, not all the metrics need to be analyzed, and only a subset is typically analyzed (e.g., the one with the best scores, as determined by an arbitrary and preferably selectable threshold). As described previously, structural or geometric-based metrics are typically compared against appropriate random score statistics, while sequence-based metrics are analyzed using statistics generated from matches of the query sequence with a randomized database. In this way, the significant structural similar surfaces 912 and significant sequence similar surfaces 916 may be further narrowed or otherwise verified.

In a further preferred embodiment, molecules having significantly similar surfaces to the query molecule as shown in box 916, as determined by the sequence-based metric comparison process 914, are re-analyzed using the corresponding substructure 906 of the query molecule and geometric-based comparison process 910. That is, for each surface returned from the sequence-based comparison process 914, the 3-D coordinates are mapped to the surface residues to form substructures, which are then loaded into surface structure motif database 920. The query substructure 906 is then compared using the structure-based metrics to each substructure in geometric-based comparison process 910. These results are indicated by box 926.

By focusing the structural comparison only on sequentially significant surfaces the inherent sequence significance may be transferred on to the substructures. Layering the structure-based metric analysis onto significant surface matches allows one to identify biologically similar surfaces more robustly. Of course, a further alternative method would be to perform sequence-based metrics only on significant structural surfaces.

In an alternative embodiment of the method, the ordering of pocket and void subsequence residues by their numbers is used as a simplistic model and does not truly reflect the actual arrangement of residues in a pocket. However, this model accurately captures the composition of residues in the pocket subsequence.

Another embodiment generates pocket and void subsequences that reflect the spatial arrangement of residues into a linear sequence and further includes pocket residues existing on multiple chains. If a similarity search is directed to protein-protein interactions, pockets and voids on the interface regions of two or more chains are considered.

A further embodiment uses a substitution matrix based on pvSOAR sequences to better reflect the composition and behavior of pockets residues from an evolutionary perspective. This substitution matrix will take into consideration only the residues of the pocket and void subsequences. Other matrices may be used such as the BLOSUM50 amino acid substitution matrix for pocket and void subsequence alignments of amino acid based on the compositions of the entire primary sequence.

One aspect of a preferred method described herein uses sequence-order dependent patterns of residues located in surface pockets and interior voids of proteins. Another aspect encompasses methods that are sequence order independent and can analyze subsequences derived from residues of multiple chains. The methods can also be applied to look at protein-protein interactions of flat surfaces using surface patterns generated by means other than geometry. If a similarity search is directed to protein-protein interactions, pockets and voids on the interface regions of two or more chains are considered.

### EXAMPLE

Given the vast number of total pockets and voids in all known protein structures, searches must be performed purposefully. A single pocket search returns too numerous results to be thoroughly analyzed. Search results were often dominated by homologous proteins, so an elaborate method of data pruning was developed to better manage to data. The following Examples illustrate the application of the methods described herein. Results are presented of a targeted pocket searches to detect similar functional surfaces among members of the same protein family. Examples are given for acetylcholinesterase, where matching of pocket patterns is shown to be specific, namely, all significantly similar matches are members of the acetylcholinesterase family. Results are then presented from an all-against-all analysis of the pvSOAR database. Using structural classification methods, similar spatial surfaces between proteins from different family, superfamily, fold, and class groups were examined.

### Example 1

Acetycholine Esterase

Acetylcholine esterase is a serine hydrolase that belongs to the esterase family. Its function is to catalyze the hydrolysis of the neurotransmitter acetylcholine by transferring the acyl group to water, forming choline and acetate. This protein acts to stop neurotransmission at cholinergic synapses frequently found in the brain. The active site contains a catalytic triad (S200, H440, and E327), located in the “aromatic gorge,” a portion of the protein that is heavily lined up with aromatic residues. Two of the catalytic residues, S200 and H440, are located in a prominent surface pocket identified by CASTp (pocket id=68, solvent accessible surface area 352 Å², volume 180 Å³) on the structure of 2ack. In addition, this pocket contains 6 G residues (residue number 117-119, 123, 335), 5 Y (70, 121, 130, 334,442), 4 F (282, 288, 290, 330, 331), 4 S (81, 122, 200, 286), 3 W (84, 233, 279), 2 L (127, 282), 2 I(287, 444), and one for each of R, D, E, H, N, Q, and P residues. The third residue E327 of the catalytic triad is not directly located in this pocket, but is located in another pocket that opens up in an opposite direction (id=66, area 44 Å², volume 11 Å³) and is immediately behind S200 and H440 in the structure of 2ack. The results of searching the pvSOAR database with the pattern of the pocket containing S200 and H440 on 2ack is shown in Table I. For this highly conserved functional surface, all significant matches at the level of E<0.1 are members of the same acetylcholine esterase-like family. Many proteins in this protein family have strong overall sequence identity. The lack of false positive hits, namely, lack of significant pocket matches from proteins of other families indicated that many acetylcholine esterase-like proteins also exhibit significant similarity in surface pocket patterns. This example demonstrated that in some cases pvSOAR database search can identify functionally related surfaces with specificity.

### Example 2

All-against-all Comparison

An all-against-all search of surface sequence patterns was conducted for each pocket and void in the pvSoar database. Applying data pruning methods reduced the number of hits for a given protein motif, but with a library still over a million sequences a high-throughput method of sorting the data was devised. With the goal of identifying novel relationships in protein surface motifs, a method of data annotation was implemented to quickly and thoroughly investigate results.

The classification methods as defined by SCOP (Murzin et al., 1995) and CATH (Orengo et al., 1997) was used to select pocket subsequence matches at different structural levels. In SCOP, proteins are classified into a hierarchy of class, fold, superfamily, and family. In CATH, proteins are classified by their class, architecture, topology, homologous superfamily, and family. For the subset of PDB structures with both SCOP and CATH labels, proteins with statistically significant similar surface patterns at various levels of discrimination were examined. Matches were required to belong to different class, fold, superfamily, or family classifications. A difference at the family level in SCOP, for example, implied the same class, fold, and superfamily classification, while a difference at the topology level in CATH implied the same class and architecture. A breakdown of the all-against-all comparison by the SCOP classification is shown in Table II and by the CATH classification is in Table III. Detailed examples from different levels are discussed below.

### Example 3

Similar Surfaces from Different CATH Families

The all-against-all comparison produced a total of 50,552 surface patterns with 10⁻⁸<E<10⁻¹ belonging to different families from the CATH classification system. Selecting only the more significant matches with E<10⁻³ reduced this number to 940. Table III shows a subset of these matches. The alpha-amylase analysis is an example of detecting functionally related binding surfaces among proteins of the same superfamily with varying overall sequence identities.

Alpha amylase. Alpha amylase is an enzyme that catalyzes the breakdown of amylose and amylopectin through hydrolysis at 1-4 glycosidic bonds (E.C. number 3.2.1.1). Alpha-amylase from B. subtilis (1bag 0) contains two domains: an α/β TIM barrel domain and a β-sandwich domain. The substrate for alpha amylase are starch, glycogen and polysaccharide, and the product of the enzyme reaction is oligosaccharide. The substrate binding site (CASTp id=60) is located on the TIM barrel domain, and is formed by 4 L residues (141, 142, 144, 210), 3 H (102, 180, 268), 2 Y (59, 62), 2 D (176, 269), 2 Q (63, 208), and 1 each of R (174), K (179), N (273), W (58) and A (177) residues. It is the largest pocket on the protein with a solvent accessible area of 181 Å³ and volume of 137 Å³. Alpha amylase from B. subtilis belongs to the glycosidase homologous superfamily within the TIM barrel topology (CATH code 3.20.20.80.25).

The partial results of searching the pvSOAR database with the pocket pattern of the substrate binding site are shown in Table V. There were 46 hits at the cut-off value of E<0.01, several of them with overall sequence identity below 25 percent as measured by full sequence alignment using SSEARCH. The matches included different structures of orthologous alpha amylase proteins from other species, as well as other functionally related members of the amylase family. For example, the alpha amylase from B. stearothermophilus (PDB id=1qho, CATH code 3.20.20.80.14) takes glucan as substrate and produces alpha-maltose, a smaller molecule than the oligosaccharide produced by alpha-amylase from B. subtilis. The matched pocket (CASTp ID=96 on chain A) contained many residues that are in the substrate binding site. If only primary sequence information was available for these two proteins, a Smith-Waterman alignment would not provide convincing evidence that these two proteins were functionally related, since their overall sequence identity is about 23 percent, well below the minimum required 30-40 percent sequence identity needed for functional correlation.

The alignment of the two pocket subsequences showed 60 percent sequence identity, corresponding to a significant E-value of 0.00042. A structural comparison between the pockets indicated that the 11 conserved residues superimposed well with an RMSD of 1.44 and a probability of 1.6×10⁻⁴. The only positional difference in the structural alignment was between N273 from 1bag and N371 from 1qho. This example demonstrated that pvSOAR database search of surface pocket pattern can detect with high sensitivity remotely related proteins of low overall sequence identity.

In addition to alpha amylases, several structures (e.g., 1cgw, 1cgv, 2dij) of cyclodextrin/cyclomaltodextrin glycosyltransferase (E.C. 2.4.1.19) were also found to have similar functional surfaces. These proteins degrade starch to cyclodextrins by formation of a 1,4-alpha-D-glucosidic bond. They are members of the glycosyltransferase sequence family, a different branch of the glycosidases superfamily by CATH classification. Their overall sequence identity to alpha amylase (1bag) are low (22 percent for 1cgw and 1cgv, 25 percent for 2dij ). The pocket structures are also significantly conserved (p-value <10×⁻⁴). These matches indicated that pvSOAR search can identify proteins of the same superfamily with closely related biological function.

### Example 4

Similar Surfaces from SCOP Folds

Proteins that share the same fold conserve structural pockets and voids regardless if they have high or low primary sequence identities. The similarity of surfaces from proteins of different fold classifications as identified from SCOP was examined. A total of 2,190,672 matches between surfaces were found with 10⁻¹⁷<E<10⁻¹. By selecting only the more significant surface patterns with E<10⁻³ the number of matched was reduced to 10,606 matches. This result is further discussed below for aromatic aminotransferase and 17-β-hydroxysteroid dehydrogenase. Results of the matches are shown in Table III.

Aromatic aminotransferase and 17-β hydroxysteroid dehydrogenase. Aromatic amino acid tranferase (AroAT) from P. dentrificans (pdb 2ay5) is a pyridoxal 5′-phosphate (PLP) cofactor dependent enzyme that catalyzes the transamination reaction. It can take both acidic and aromatic amino acid as substrates. A series of aliphatic monocarboxylates attached to the bulky hydrophobic groups can bind to the active sites. These compounds contain three moieties: the carboxylic group, an aliphatic chain of 2-4 C atoms, and a functional hydrophobic probing group. The substrate binding site is found to be the most prominent pocket on 2ay5 (area 797 Å²and volume 514 Å³). It is formed at the dimer interface, but the majority (45) of the 51 wall residues comes from chain A. The results of searching pvSOAR database with the pocket pattern from chain A are listed in Table VI and VII. As expected, the highest scoring matches were the search pattern itself, and patterns from many other PDB structures of aromatic amino transferases. Additional high scoring matches included many structures of aspartic amino transferase.

A surprising match was 17-β-hydroxysteroid dehydrogenase (17-β-HD, pdb 1fdw, at significant E-value of 0.00021). 17-β-HD belongs to NADP-binding Rossman fold, which is different by SCOP classification from the fold of aromatic amino transferase (PLP-dependent transferase fold). It is a key enzyme in the estrone metabolic pathway and it catalyzes the conversion of estradiol-17-beta to estrone. This is a different chemical reaction than that catalyzed by aromatic aminotransferase. The substrate binding site of 17-β-HD is located at the most prominent pocket on 1fdw (CASTp ID 39, area 818 Å² and volume 844 A³). This binding site pocket contains 59 residues. When searching pvSOAR database with the pocket pattern of the 59 residues from 1fdw, the strongest matches were other structures of 17-β-hydroxysteroid dehydrogenase as expected, but structures of aromatic amino transferases were also found as matches at significant levels (E-value of 0.00053 for the structure with the highest match scores of AroAT).

The success of the bidirectional search using both surface patterns as query in identifying the other indicated that the similarity between the functional surfaces of these two proteins is high. The functional roles of the conserved residues in these two patterns provide some rationalization of the detected surface similarity. Among these, 17 residue pairs are identical or are physicochemically homologous. G36 and F360 from 2ay5 interact with the carboxyl group and the aliphatic group of the substrate. N142 and T109 recognize the aromatic groups through van der Waals interactions with the substrate. K258, G108, T109, S257, and Y225 bind to PLP. All these residues are conserved in 17-β-HD. Conversely, 6 conserved residues in the binding site of 17-β-HD interact with the hydrophobic group of the substrate: S142, P187, Y218, S222, F226, F259, and E282. The corresponding conserved residues on AroAT are T109, P195, Y225, S257, F360, Y380, and D384. Altogether, 10 of the 17 conserved residue pairs have clear functional roles in binding substrate in either AroAT or in 17-β-HD as assessed from the structures of 2ay5 and 1fdw. The conserved residues that are known to bind to other substrate analogs in other PDB structures were not taken into account. These results suggested that the similar patterns of the binding surfaces of aromatic aminotransferase and 17-β-HD may be related to the shared functional role of binding a bulky and hydrophobic group.

The overall RMSD between the two pockets showed borderline statistical significance (9.58 Å) with a probability of 1.2×10⁻¹. However, after being transposed to the pocket sphere structure, the two pockets can be superimposed with an RMSD of 1.02 Å with a probability of 3.6×10⁻⁵. This normalized view of the pockets again showed how the spatial orientation of the pocket residues is emphasized over the spatial distance of the residues. The results suggested that the similar patterns of the binding surfaces of aromatic aminotransferase and 17-β-HD may be related to the shared similar functional role of binding a bulky and hydrophobic group.

These data also suggested an intriguing possibility that these two enzymes might be related evolutionarily. Residues 117-152 from 1fdw aligned with residues 108-142 from lay5. In 1fdw, they form an alpha helix, and a longer beta strand. In 1ay4, they form an alpha helix and a shorter beta strand. At the end (beginning) of this segment, both proteins have a short loop region. The relative spatial arrangement of these residues was rather similar. The main difference was that in I fdw the alpha helix and the beta strand are very close to each other, whereas in 2ay5 the angle between them is bigger. For 1fdw, residues 222-227 are in an alpha helix. The corresponding residues in 2ay5 are 257-258 (loop) and 360, 362 (beta strand). In 2ay5, these residues are close to alpha helix 13, forming a closed triangle, where they are in a more open configuration in 1fdw with a large distance to the alpha helix. Residues C185 and P187 in 1fdw are both located in a loop region between F226 and G141, S142. Similarly, the corresponding C192 and P195 in 2ay5 are located in a loop region between F360, which corresponds to F226 in 1fdw and additionally to R362 involved in specificity. The conserved secondary structures may provide favorable locations for functional residues, suggesting a general gene recruitment event.

### Example 5

Similar Surface From Different Classes

A total of 6,782,867 (4,081,149 from SCOP and 2,701,718 from CATH) matches of surface patterns subsequences with 10⁻¹⁷<E<10⁻¹ were found between pockets from proteins of different SCOP or CATH classes. Only those matches with E<10⁻³ were considered and significant disagreement between SCOP and CATH were found. For example, matches were founds for three dimensional structures of two proteins that were classified in the same class by SCOP but in different classes by CATH or for three-dimensional structures of two proteins that were classified in the same class by CATH but in different classes by SCOP. There were also many structures that were classified in one but not in the other system. A subset of pairs of protein structures which were classified by both systems and were in different classes according to SCOP and CATH were selected reducing the number of matches to 8,990. When these matches were further prunned using the criteria described above, 50 pairs of matched subsequence patterns were obtained. A subset of this list, comprised of a single representative match for multiple matches to the same subsequence pocket is shown in Table X.

HIV-1 and Human Shock Protein 90. Human immunodeficiency virus type-1 protease is bound to the substrate-based inhibitor acetyl-pepstatin (PDB id=5hvp) which is studied as a potential therapeutic agent for the treatment of acquired immune deficiency syndrome. The protein is an all-β dimer of identical single domain chains, each with a (6,10) barrel, belonging to the family of retroviral proteases (SCOP code b.50.1.1). The largest pocket (CASTp id=21, solvent accessible area=529.9 Å², volume=415.0 Å³) has 2 mouths and is formed by a series of loops and flaps (named for their flexibility across their family). Acetyl-pepstatin (isovaleral-Val-Val-Sta-Ala-Sta) binds through both hydrophobic and nonbonded interactions with residues in the loop and flaps. Of the 10 residues that participate in hydrogen bonds with the inhibitor, 9 of them are located within pocket 21.

A similar surface was discovered from a pocket in heat shock protein 90 (Hsp90 from Homo sapiens) molecular chaperone with geldanamycin bound to it. Hsp90(PDB id=1yes) has dual chaperone functions participating both in the conformational maturation of nuclear hormone receptors and protein kinases and in cellular stress response. The protein consists of 9 helices and an anti-parallel β-sheet of 8 strands that fold into an α/β sandwich. It is classified in the Hsp90 family (SCOP classification d.122.1.1). A deep binding pocket (15 Å) is formed from 3 helices and a loop with the sheets forming the bottom. It is the largest pocket on the protein with solvent accessible surface area of 322.0 Å² and volume 252.5 Å³. The pocket consists primarily of hydrophobic groups except for a single, buried aspartic acid (93). Geldanamycin comprises a carbamate group, which is actively involved in binding geldanmycin to the protein. Geldanamycin has been detected to have anti-tumor activity, and is known to inhibit the folding of the Hsp90 chaperone.

The sequences aligned with an expectation value of 8.0×10⁻³. There were 10 residues conserved between the alignment of length 15: K58, 191, D93, G97, D102, G132, G135, V136, G137, F138 from lyes and R207, L223, D225, G227, D229, G248, G249, I250, G252, F253 from 5hvp. The residues from HIV-1 protease show that that the key residues involved in binding the substrate are conserved. Residues D229, G227, D225 form hydrogen bonds with the body of the protein and residue G248 forms hydrogen bonds with the flap. Corresponding residues from Hsp90 (D93, G97, D102, G132) are also involved in substrate binding. A strong hydrogen bond network exists between D93 and geldanamycin. Van der Waals interactions exist with D102 and hydrogen bonds are formed from G97. The critical role of the conserved residues in binding their substrates provides some explanation for the similarity between these two pvSOAR sequences.

The entire pocket of HIV-1 protease is approximately 1.5 times the size of Hsp90. The pockets superimposed to with an RMSD of 7.21 Å with a probability of 1.4×10⁻¹. The conserved residues of the structure 5hvp have a linear orientation, while the conserved residues from the structure lyes have a ring-like orientation. Despite this cursory shape difference the superimposition of the pocket spheres was 0.73 Å with a probability of 2.3×10⁻⁵ indicating that the relative position of the conserved residues is extremely similar.

Both pockets also have other characteristics that reveal similarities. Both pockets are lined mainly with hydrophobic side chains with a strategically located functional aspartic acid residue. The structures of the bound substrates show high surface complementary to the pocket surface, which supports previous findings that the size and shape of both these pockets undergo significant conformational changes when bound. The geldanamycin ansa ring is conformationally similar to a five amino acid polypeptide in a turn conformation and hydrogen bonding considerations could be emulated by substituting amino acids. The results indicated that a similar surface in HIV-1 protease shared commonalities, namely a large, flexible surface with accommodating electrostatic distributions for substrate binding that is similar to a surface in Hsp90.

TABLE I
Search results with the pocket (68) forming the catalytic triad from Acetylcholinesterase (2ack_0).

| PDB | Pocket | Chain | | | CATH | SCOP | | Backbone | Aligned | Pocket | |
|---|---|---|---|---|---|---|---|---|---|---|---|
| code | ID | ID | E | Fold | ID | ID | Structure | Seq. IDE. | atoms | RMSD | p-value |
| 1cfj | 64 | A | 8.10e−20 | α/β | 3.40.50.950 | c.69.1.1 | Acetylcholinesterase | 1.000 | 33 | 0.61 | 1.6e−11 |
| 2ace | 62 | 0 | 8.10e−20 | α/β | 3.40.50.950 | c.69.1.1 | Acetylcholinesterase | 1.000 | 33 | 0.66 | 3.2e−11 |
| 1ax9 | 71 | 0 | 8.10e−20 | α/β | 3.40.50.950 | c.69.1.1 | Acetylcholinesterase | 1.000 | 33 | 0.36 | 3.0e−13 |
| 1qie | 79 | A | 1.50e−18 | α/β | 3.40.50.950 | c.69.1.1 | Acetylcholinesterase | 1.000 | 33 | 0.51 | 3.5e−12 |
| 1qii | 83 | A | 1.50e−18 | α/β | 3.40.50.950 | c.69.1.1 | Acetylcholinesterase | 1.000 | 33 | 0.60 | 1.3e−11 |
| 1ea5 | 79 | A | 1.80e−18 | α/β | 3.40.50.950 | c.69.1.1 | Acetylcholinesterase | 1.000 | 31 | 0.53 | 3.0e−12 |
| 1acl | 50 | 0 | 1.80e−18 | α/β | 3.40.50.950 | c.69.1.1 | Acetylcholinesterase | 1.000 | 31 | 0.66 | 2.2e−11 |
| 1som | 70 | A | 2.50e−18 | α/β | n/a | c.69.1.1 | Acetylcholinesterase | 1.000 | 33 | 0.60 | 1.4e−11 |
| 1qih | 80 | A | 4.90e−18 | α/β | 3.40.50.950 | c.69.1.1 | Acetylcholinesterase | 1.000 | 32 | 0.51 | 5.6e−12 |
| 1qim | 84 | A | 2.80e−17 | α/β | 3.40.50.950 | c.69.1.1 | Acetylcholinesterase | 1.000 | 33 | 0.69 | 5.2e−11 |
| 1qif | 74 | A | 2.80e−17 | α/β | 3.40.50.950 | c.69.1.1 | Acetylcholinesterase | 1.000 | 33 | 0.56 | 7.4e−12 |
| 1qig | 78 | A | 2.80e−17 | α/β | 3.40.50.950 | c.69.1.1 | Acetylcholinesterase | 1.000 | 33 | 0.58 | 1.0e−11 |
| 1qij | 84 | A | 2.80e−17 | α/β | 3.40.50.950 | c.69.1.1 | Acetylcholinesterase | 1.000 | 33 | 0.65 | 2.8e−11 |
| 1maa | 286 | D | 5.30e−17 | α/β | 3.40.50.950 | c.69.1.1 | Acetylcholinesterase | 0.590 | 32 | 0.82 | 4.7e−10 |
| 1maa | 285 | A | 5.30e−17 | α/β | 3.40.50.950 | c.69.1.1 | Acetylcholinesterase | 0.590 | 32 | 0.80 | 3.3e−10 |
| 1oce | 63 | 0 | 8.90e−17 | α/β | 3.40.50.950 | c.69.1.1 | Acetylcholinesterase | 1.000 | 32 | 0.63 | 3.5e−11 |
| 1qik | 83 | A | 9.20e−17 | α/β | 3.40.50.950 | c.69.1.1 | Acetylcholinesterase | 1.000 | 32 | 0.66 | 4.9e−11 |
| 1vxr | 76 | A | 5.10e−16 | α/β | 3.40.50.950 | c.69.1.1 | Acetylcholinesterase | 1.000 | 28 | 0.67 | 7.2e−13 |
| 1eve | 73 | 0 | 6.10e−16 | α/β | 3.40.50.950 | c.69.1.1 | Acetylcholinesterase | 1.000 | 31 | 0.61 | 9.3e−12 |
| 1qid | 73 | A | 6.30e−16 | α/β | 3.40.50.950 | c.69.1.1 | Acetylcholinesterase | 1.000 | 31 | 0.54 | 3.6e−12 |
| 1vxo | 85 | A | 7.80e−16 | α/β | 3.40.50.950 | c.69.1.1 | Acetylcholinesterase | 1.000 | 31 | 0.59 | 7.6e−12 |
| 1amm | 78 | 0 | 8.70e−16 | α/β | 3.40.50.950 | c.69.1.1 | Acetylcholinesterase | 0.991 | 33 | 0.60 | 1.3e−11 |
| 1dx6 | 75 | A | 1.00e−15 | α/β | 3.40.50.950 | c.69.1.1 | Acetylcholinesterase | 1.000 | 31 | 0.69 | 3.3e−11 |
| 1vot | 57 | 0 | 2.80e−15 | α/β | 3.40.50.950 | c.69.1.1 | Acetylcholinesterase | 1.000 | 32 | 0.65 | 4.1e−11 |
| 1fss | 73 | A | 4.60e−15 | α/β | 3.40.50.950 | c.69.1.1 | Acetylcholinesterase | 1.000 | 32 | 1.10 | 1.3e−08 |
| 1qti | 69 | A | 9.50e−15 | α/β | 3.40.50.950 | c.69.1.1 | Acetylcholinesterase | 1.000 | 28 | 0.81 | 8.6e−12 |
| 1c2o | 318 | C | 2.00e−13 | α/β | n/a | c.69.1.1 | Acetylcholinesterase | 0.590 | 31 | 0.88 | 4.6e−10 |
| 1c2b | 87 | A | 2.00e−13 | α/β | n/a | c.69.1.1 | Acetylcholinesterase | 0.590 | 31 | 0.88 | 4.6e−10 |
| 1c2o | 319 | A | 2.00e−13 | α/β | n/a | c.69.1.1 | Acetylcholinesterase | 0.590 | 31 | 0.88 | 4.6e−10 |
| 1acj | 79 | 0 | 8.30e−13 | α/β | 3.40.50.950 | c.69.1.1 | Acetylcholinesterase | 1.000 | 33 | 0.89 | 6.6e−10 |
| 1f8u | 97 | A | 1.80e−12 | α/β | n/a | c.69.1.1 | Acetylcholinesterase | 0.574 | 25 | 7.39 | 3.2e−01 |
| 1b41 | 104 | A | 2.80e−12 | α/β | n/a | c.69.1.1 | Acetylcholinesterase | 0.578 | 27 | 7.52 | 3.4e−01 |
| 1e3q | 83 | A | 5.20e−12 | α/β | 3.40.50.950 | c.69.1.1 | Acetylcholinesterase | 1.000 | 31 | 2.10 | 4.1e−05 |
| 1mah | 107 | A | 5.70e−12 | α/β | n/a | c.69.1.1 | Acetylcholinesterase | 0.590 | 30 | 0.87 | 2.3e−11 |
| 1maa | 288 | C | 2.30e−11 | α/β | 3.40.50.950 | c.69.1.1 | Acetylcholinesterase | 0.590 | 30 | 3.16 | 6.2e−03 |
| 2dfp | 78 | A | 1.20e−10 | α/β | 3.40.50.950 | c.69.1.1 | Acetylcholinesterase | 0.998 | 28 | 1.50 | 8.2e−08 |
| 1maa | 287 | B | 2.00e−10 | α/β | 3.40.50.950 | c.69.1.1 | Acetylcholinesterase | 0.590 | 27 | 2.80 | 4.8e−03 |
| 1qo9 | 86 | A | 2.10e−06 | α/β | 3.40.50.950 | c.69.1.1 | Acetylcholinesterase | 0.370 | 21 | 4.24 | 8.5e−02 |
| 1c2o | 326 | D | 5.70e−06 | α/β | n/a | c.69.1.1 | Acetylcholinesterase | 0.590 | 24 | 4.66 | 1.5e−01 |
| 1qon | 86 | A | 1.30e−03 | α/β | 3.40.50.950 | c.69.1.1 | Acetylcholinesterase | 0.370 | 18 | 1.77 | 1.7e−04 |
| 1c2o | 326 | B | 1.30e−03 | α/β | n/a | c.69.1.1 | Acetylcholinesterase | 0.590 | 24 | 4.63 | 1.4e−01 |
| 1dx4 | 76 | A | 5.30e−02 | α/β | 3.40.50.950 | c.69.1.1 | Acetylcholinesterase | 0.370 | 18 | 2.89 | 1.9e−02 |

This table gives the pdb code, the pocket identification number generated by castp, the chain identification number, protein name, the fold according to scop, and the scop identification number. N/a indicates that no information was available at the time of publication.

TABLE II
Breakdown of hits from all-vs-all comparision using SCOP classification.

| E-value | Total | Same | NA | Different | Class | Fold | Superfamily | Family |
|---|---|---|---|---|---|---|---|---|
| 10e−17 | 117582 | 87501 | 30081 | 0 | 0 | 0 | 0 | 0 |
| 10e−16 | 16236 | 11449 | 4787 | 0 | 0 | 0 | 0 | 0 |
| 10e−15 | 18707 | 13127 | 5580 | 0 | 0 | 0 | 0 | 0 |
| 10e−14 | 22068 | 15697 | 6371 | 0 | 0 | 0 | 0 | 0 |
| 10e−13 | 24915 | 17892 | 7023 | 0 | 0 | 0 | 0 | 0 |
| 10e−12 | 28197 | 20006 | 8191 | 0 | 0 | 0 | 0 | 0 |
| 10e−11 | 31710 | 22381 | 9329 | 0 | 0 | 0 | 0 | 0 |
| 10e−10 | 43154 | 32419 | 10735 | 0 | 0 | 0 | 0 | 0 |
| 10e−9 | 47982 | 36363 | 11619 | 0 | 0 | 0 | 0 | 0 |
| 10e−8 | 55556 | 42406 | 13147 | 3 | 0 | 0 | 0 | 3 |
| 10e−7 | 63582 | 47683 | 15884 | 15 | 2 | 2 | 0 | 11 |
| 10e−6 | 80241 | 58353 | 21798 | 90 | 17 | 14 | 1 | 58 |
| 10e−5 | 86698 | 61624 | 24773 | 301 | 122 | 79 | 1 | 99 |
| 10e−4 | 101351 | 67887 | 31569 | 1895 | 1175 | 527 | 16 | 177 |
| 10e−3 | 181352 | 86040 | 67191 | 28121 | 17163 | 9984 | 382 | 592 |
| 10e−2 | 1041265 | 124269 | 468495 | 448501 | 282157 | 157617 | 4938 | 3789 |
| 10e−1 | 11600033 | 248929 | 5439821 | 5911283 | 3780513 | 2022449 | 62498 | 45823 |

TABLE III
Breakdown of hits from all-vs-all comparision using CATH classification.

| | | | | | | | | Homologous |
|---|---|---|---|---|---|---|---|---|
| E-value | Total | Same | NA | Different | Class | Architecture | Topology | Superfamily |
| 10e−17 | 117582 | 70950 | 46383 | 249 | 245 | 0 | 4 | 0 |
| 10e−16 | 16236 | 9934 | 6288 | 14 | 14 | 0 | 0 | 0 |
| 10e−15 | 18707 | 11275 | 7400 | 32 | 32 | 0 | 0 | 0 |
| 10e−14 | 22068 | 13590 | 8452 | 26 | 22 | 0 | 4 | 0 |
| 10e−13 | 24915 | 15464 | 9436 | 15 | 15 | 0 | 0 | 0 |
| 10e−12 | 28197 | 17423 | 10763 | 11 | 11 | 0 | 0 | 0 |
| 10e−11 | 31710 | 19929 | 11759 | 22 | 20 | 0 | 2 | 0 |
| 10e−10 | 43154 | 29293 | 13828 | 33 | 31 | 0 | 2 | 0 |
| 10e−9 | 47982 | 32543 | 15404 | 35 | 32 | 0 | 3 | 0 |
| 10e−8 | 55556 | 38140 | 17358 | 58 | 54 | 0 | 4 | 0 |
| 10e−7 | 63582 | 43177 | 20316 | 89 | 84 | 1 | 4 | 0 |
| 10e−6 | 80241 | 52790 | 27304 | 147 | 116 | 13 | 17 | 1 |
| 10e−5 | 86698 | 55828 | 30542 | 328 | 253 | 38 | 33 | 4 |
| 10e−4 | 101351 | 60800 | 38978 | 1573 | 997 | 357 | 155 | 64 |
| 10e−3 | 181352 | 77137 | 82196 | 22019 | 11482 | 5967 | 3611 | 959 |
| 10e−2 | 1041265 | 108415 | 580491 | 352359 | 185133 | 94215 | 56138 | 16873 |
| 10e−1 | 11600033 | 229803 | 6681895 | 4688335 | 2503177 | 1228868 | 740224 | 216066 |

TABLE IV
Significant pocket matches between proteins from different families.

| Query | | | Hit | | | | | | | | |
|---|---|---|---|---|---|---|---|---|---|---|---|
| PDB | Pocket | Chain | PDB | Pocket | Chain | Seq Align | | Pocket | | Sphere | |
| code | id | id | code | id | id | E() | Atoms | Rmsd | P() | RMSD | P() |
| 1qfy | 65 | A | 1ddi | 46 | A | 2.0e−04 | 12 | 0.83 | 5.9e−06 | 0.09 | 0.0e+00 |
| 1a85 | 23 | A | 1bkc | 125 | I | 1.0e−02 | 8 | 0.89 | 6.6e−06 | 0.10 | 0.0e+00 |
| 1arm | 38 | 0 | 1obr | 40 | 0 | 1.9e−03 | 15 | 0.92 | 6.2e−04 | 0.11 | 0.0e+00 |
| 1ddi | 46 | A | 1qfy | 65 | A | 3.6e−04 | 13 | 0.92 | 1.4e−05 | 0.11 | 0.0e+00 |
| 1obr | 40 | 0 | 1arm | 38 | 0 | 2.1e−03 | 15 | 0.92 | 6.2e−04 | 0.11 | 0.0e+00 |
| 1bag | 60 | 0 | 1qho | 96 | A | 0.0e+00 | 11 | 1.44 | 1.1e−03 | 0.12 | 0.0e+00 |
| 1qcf | 56 | A | 1bx6 | 61 | 0 | 1.3e−03 | 18 | 2.36 | 4.8e−04 | 0.25 | 0.0e+00 |
| 1b38 | 36 | A | 1qcf | 56 | A | 5.2e−03 | 21 | 2.45 | 7.6e−04 | 0.28 | 0.0e+00 |
| 1fgk | 71 | B | 1apm | 61 | E | 5.3e−03 | 13 | 2.76 | 3.8e−02 | 0.30 | 0.0e+00 |
| 1apm | 61 | E | 1fgk | 71 | B | 1.5e−03 | 15 | 2.84 | 4.4e−02 | 0.30 | 0.0e+00 |
| 1sgt | 23 | 0 | 1ddj | 141 | C | 3.1e−03 | 14 | 3.28 | 1.1e−01 | 0.52 | 0.0e+00 |
| 1b17 | 56 | A | 2hck | 133 | A | 1.1e−03 | 17 | 3.53 | 1.1e−01 | 0.43 | 0.0e+00 |
| 1vsc | 44 | B | 1g9m | 156 | L | 3.4e−03 | 7 | 3.65 | 3.2e−01 | 0.72 | 2.8e−02 |
| 1qpc | 46 | A | 1b16 | 45 | A | 9.6e−03 | 9 | 3.96 | 3.6e−01 | 0.58 | 6.2e−19 |
| 1do0 | 169 | E | 2ncd | 56 | A | 6.4e−03 | 6 | 4.01 | 2.3e−01 | 1.08 | 2.7e−01 |
| 1efh | 53 | A | 1d9z | 120 | A | 8.6e−03 | 6 | 4.28 | 2.2e−01 | 0.91 | 3.7e−01 |
| 1dgs | 179 | B | 1eqr | 194 | B | 6.8e−03 | 8 | 5.72 | 2.0e−01 | 0.66 | 1.5e−05 |
| 1eem | 34 | A | 1bq7 | 95 | E | 9.8e−03 | 7 | 5.77 | 2.0e−01 | 0.81 | 1.4e−01 |
| 1db3 | 29 | A | 1leh | 89 | B | 6.7e−03 | 7 | 9.27 | 1.8e−02 | 0.95 | 3.6e−01 |

The lines groups entries by pocket rmsd value. Entries are then sorted by sphere p-value.

TABLE V
Amylase Matches.

| PDB | Pocket | Chain | E-value | | Backbone | Conserved | Pocket | |
|---|---|---|---|---|---|---|---|---|
| code | id | id | value | Name | Seq. Id. | Atoms | RMSD | p-value |
| 1bag | 60 | 0 | 6e−12 | Alpha-1,4-Glucan-4-Glucanohydrolase | 1.000 | 18 | 0.00 | 8.3e−12 |
| 1jae | 57 | 0 | 8e−09 | Alpha-Amylase | 0.244 | 14 | 0.48 | 1.8e−10 |
| 1b2y | 80 | A | 9.8e−09 | Alpha-Amylase | 0.237 | 14 | 0.49 | 1.9e−08 |
| 1kgu | 77 | A | 1.1e−07 | Alpha-Amylase, Pancreatic | 0.244 | 15 | 1.88 | 1.9e−03 |
| 1jfh | 81 | 0 | 1.8e−07 | Alpha-Amylase | 0.233 | 14 | 0.43 | 7.7e−09 |
| 1kgw | 63 | A | 5.6e−07 | Alpha-Amylase, Pancreatic | 0.244 | 14 | 0.52 | 2.5e−08 |
| 2cpu | 70 | A | 1.5e−06 | Alpha-Amylase | 0.235 | 11 | 0.41 | 1.4e−09 |
| 1pif | 75 | 0 | 5.2e−06 | Alpha-Amylase | 0.239 | 14 | 1.98 | 3.2e−03 |
| 1pig | 85 | 0 | 5.4e−06 | Alpha-Amylase | 0.239 | 14 | 0.44 | 8.8e−09 |
| 1ose | 82 | 0 | 5.4e−06 | Porcine Alpha-Amylase | 0.233 | 14 | 0.50 | 2.1e−08 |
| 1cpu | 84 | A | 9.6e−06 | Alpha-Amylase | 0.237 | 14 | 1.17 | 2.1e−05 |
| 3cpu | 68 | A | 1.1e−05 | Alpha-Amylase | 0.235 | 12 | 0.66 | 3.4e−09 |
| 1hx0 | 82 | A | 1.4e−05 | Alpha Amylase (Ppa) | 0.236 | 13 | 0.42 | 7.1e−09 |
| 1ppi | 81 | 0 | 1.4e−05 | Alpha Amylase (Ppa) (E.C. 3.2.1.1) | 0.236 | 13 | 0.45 | 9.5e−09 |
| 1c8q | 70 | A | 1.6e−05 | Alpha-Amylase | 0.239 | 14 | 2.24 | 8.9e−03 |
| 1hny | 82 | 0 | 2.3e−05 | Human Pancreatic Alpha-Amylase | 0.237 | 10 | 3.59 | 3.1e−01 |
| 1jxk | 77 | A | 3.8e−05 | Alpha-Amylase, Salivary | 0.242 | 10 | 3.65 | 3.2e−01 |
| 1smd | 86 | 0 | 4.0e−05 | Amylase | 0.239 | 10 | 3.58 | 3.1e−01 |
| 1b0i | 73 | A | 4.4e−05 | Alpha-Amylase | 0.254 | 14 | 0.53 | 4.3e−10 |
| 1e3z | 70 | A | 4.6e−05 | Alpha-Amylase | 0.228 | 11 | 2.26 | 1.7e−02 |
| 1bli | 67 | 0 | 4.6e−05 | Alpha-Amylase | 0.235 | 11 | 2.44 | 3.1e−02 |
| 1e3z | 70 | A | 4.6e−05 | Alpha-Amylase | 0.228 | 11 | 2.26 | 1.7e−02 |
| 1hvx | 69 | A | 4.6e−05 | Alpha-Amylase | 0.235 | 11 | 2.37 | 2.5e−02 |
| 2dij | 90 | 0 | 4.8e−05 | Cyclodextrin Glycosyltransferase | 0.221 | 11 | 1.41 | 3.0e−05 |
| 1g94 | 66 | A | 5.3e−05 | Alpha-Amylase | 0.254 | 11 | 0.33 | 3.3e−10 |
| 1bsi | 69 | 0 | 5.6e−05 | Alpha-Amylase | 0.237 | 13 | 1.83 | 6.7e−04 |
| 2cxg | 85 | 0 | 7.8e−05 | Cyclodextrin Glycosyltransferase | 0.221 | 11 | 1.43 | 1.5e−04 |
| 1kck | 91 | A | 7.8e−05 | Cyclodextrin Glycosyltransferase | 0.223 | 11 | 1.53 | 2.7e−04 |
| 1aqh | 71 | 0 | 8.5e−05 | Alpha-Amylase | 0.254 | 13 | 0.51 | 2.3e−08 |
| 1aqm | 69 | 0 | 8.5e−05 | Alpha-Amylase | 0.254 | 13 | 0.43 | 7.9e−09 |
| 1cgw | 93 | 0 | 0.00011 | Cyclomaltodextrin Glucanotransferasee | 0.223 | 11 | 1.61 | 1.5e−04 |
| 7taa | 82 | 0 | 0.00018 | Taka Amylase | 0.249 | 11 | 1.13 | 3.6e−05 |
| 1qho | 96 | A | 0.00042 | Alpha-Amylase | 0.220 | 11 | 1.44 | 1.6e−04 |
| 1qhp | 101 | A | 0.00045 | Alpha-Amylase | 0.220 | 11 | 1.40 | 1.2e−04 |
| 1e40 | 67 | A | 0.00093 | Alpha-Amylase | 0.228 | 10 | 1.72 | 3.2e−04 |
| 1e43 | 61 | A | 0.00093 | Alpha-Amylase | 0.228 | 10 | 1.79 | 5.1e−04 |
| 1e3x | 68 | A | 0.00093 | Alpha-Amylase | 0.228 | 10 | 1.92 | 1.2e−03 |
| 1jxj | 77 | A | 0.001 | Alpha-Amylase, Salivary | 0.237 | 9 | 2.58 | 4.6e−02 |
| 1cgv | 77 | 0 | 0.0018 | Cyclomaltodextrin Glucanotransferase2 | 0.221 | 11 | 1.70 | 7.5e−04 |
| 5cgt | 88 | 0 | 0.002 | Cyclodextrin Glycosyltransferase | 0.232 | 10 | 2.39 | 1.5e−02 |
| 1cxh | 84 | 0 | 0.0024 | Cyclodextrin Glycosyltransferase | 0.221 | 11 | 1.61 | 4.6e−04 |
| 1kcl | 88 | A | 0.0024 | Cyclodextrin Glycosyltransferase | 0.221 | 11 | 1.67 | 6.5e−04 |
| 1i75 | 149 | A | 0.0027 | Cyclodextrin Glucanotransferase | 0.240 | 11 | 1.65 | 2.0e−04 |
| 1dtu | 84 | A | 0.0049 | Cyclodextrin Glycosyltransferase | 0.225 | 10 | 2.30 | 1.1e−02 |
| 1cgt | 91 | 0 | 0.007 | Cyclodextrin Glycosyltransferase | 0.234 | 11 | 5.19 | 3.7e−01 |
| 1cgy | 76 | 0 | 0.0096 | Cyclomaltodextrin Glucanotransferase | 0.221 | 9 | 1.79 | 1.3e−03 |

TABLE VI
PDB structures containing pocket surfaces that are similar to the functional site of
aromatic aminotransferase (2ay5). The hits listed are obtained by querying pvSOAR
database with the pattern obtained from pocket 110 on chain A of 2ay5. All have
significant E-values ≦ 0.01. The most significant hit is the query pattern itself.
There are 87 hits from structures of aromatic aminotransferase and aspartic
aminotransferase with E-values between 5.1e−26 and 1.1e−5. Only one (1aam) is
listed for brevity. All hits with E values between 1.0e−5 and 0.01 are
listed. Two 17-beta-hydrosysteroid dehydrogenase structures are identified with
ignificant E values of 0.00021 and 0.0086.

| PDB | | | | | Full | |
|---|---|---|---|---|---|---|
| code | Pocket id | Chain id | E-value | Name | Sequence | Identity |
| 2ay5 | 110 | A | 5.1e−26 | Aromatic Amino Acid | 1.000000 | 394 |
| | | | | Aminotransferase | | |
| 1aam | 63 | 0 | 1.3e−11 | Aspartate Aminotransferase (E.C. | 0.457000 | 396 |
| | | | | 2.6.1.1) Mu | | |
| 1asl | 125 | A | 1.1e−05 | Aspartate Aminotransferase (E.C. | 0.460000 | 396 |
| | | | | 2.6.1.1) (W | | |
| 2aat | 83 | 0 | 1.6e−05 | Aspartate Aminotransferase (E.C. | 0.457000 | 396 |
| | | | | 2.6.1.1) Mu | | |
| 1asn | 140 | A | 1.6e−05 | Aspartate Aminotransferase (E.C. | 0.460000 | 396 |
| | | | | 2.6.1.1) (W | | |
| 8aat | 127 | B | 2.2e−05 | Aspartate Aminotransferase (E.C. | 0.361000 | 388 |
| | | | | 2.6.1.1) Co | | |
| 1arg | 138 | A | 2.9e−05 | Aspartate Aminotransferase | 0.460000 | 396 |
| 1asm | 150 | A | 2.9e−05 | Aspartate Aminotransferase (E.C. | 0.460000 | 396 |
| | | | | 2.6.1.1) (W | | |
| 1ahe | 132 | B | 3.8e−05 | Aspartate Aminotransferase | 0.449000 | 396 |
| 1ajs | 112 | A | 4.3e−05 | Aspartate Aminotransferase | 0.366000 | 399 |
| 1asm | 149 | B | 7.8e−05 | Aspartate Aminotransferase (E.C. | 0.460000 | 396 |
| | | | | 2.6.1.1) (W | | |
| 1tas | 119 | A | 1.4e−04 | Aspartate Aminotransferase | 0.361000 | 388 |
| | | | | (Maspat) (E.C. 2. | | |
| 1art | 66 | 0 | 1.7e−04 | Aspartate Aminotransferase (E.C. | 0.460000 | 396 |
| | | | | 2.6.1.1) Co | | |
| 1arg | 139 | B | 2.1e−04 | Aspartate Aminotransferase | 0.460000 | 396 |
| 1fdw | 39 | 0 | 2.1e−04 | 17-Beta-Hydroxysteroid | 0.276000 | 58 |
| | | | | Dehydrogenase | | |
| 1ari | 146 | A | 2.7e−04 | Aspartate Aminotransferase | 0.457000 | 396 |
| 1aka | 130 | A | 3.9e−04 | Aspartate Aminotransferase (E.C. | 0.358000 | 388 |
| | | | | 2.6.1.1) Mu | | |
| 1ajs | 113 | B | 5.1e−04 | Aspartate Aminotransferase | 0.363000 | 399 |
| 1qir | 67 | A | 6.4e−04 | Aspartate Aminotransferase | 0.457000 | 396 |
| 1ama | 52 | 0 | 6.5e−04 | Aspartate Aminotransferase (E.C. | 0.361000 | 388 |
| | | | | 2.6.1.1) Co | | |
| 1maq | 64 | 0 | 7.5e−04 | Aspartate Aminotransferase | 0.361000 | 388 |
| | | | | (Maspat) (E.C. 2. | | |
| 1ahg | 150 | B | 8.6e−04 | Aspartate Aminotransferase | 0.449000 | 396 |
| 1ajr | 99 | B | 8.9e−04 | Aspartate Aminotransferase | 0.363000 | 399 |
| 1ivr | 56 | A | 1.5e−03 | Aspartate Aminotransferase | 0.361000 | 388 |
| 1ari | 147 | B | 1.5e−03 | Aspartate Aminotransferase | 0.457000 | 396 |
| 1tat | 136 | A | 2.7e−03 | Aspartate Aminotransferase | 0.361000 | 388 |
| | | | | (Maspat) (E.C. 2. | | |
| 1ajr | 98 | A | 3.7e−03 | Aspartate Aminotransferase | 0.363000 | 399 |
| 1oxp | 56 | 0 | 4.2e−03 | Aspartate Aminotransferase | 0.361000 | 388 |
| 1ams | 62 | 0 | 4.8e−03 | Aspartate Aminotransferase (E.C. | 0.460000 | 396 |
| | | | | 2.6.1.1) Co | | |
| 1yaa | 229 | D | 6.0e−03 | Aspartate Aminotransferase | 0.336000 | 405 |
| 1tat | 137 | B | 7.4e−03 | Aspartate Aminotransferase | 0.361000 | 388 |
| | | | | (Maspat) (E.C. 2. | | |
| 1yaa | 231 | B | 8.0e−03 | Aspartate Aminotransferase | 0.336000 | 405 |
| 1bhs | 30 | 0 | 8.6e−03 | 17Beta-Hydroxysteroid | 0.276000 | 58 |
| | | | | Dehydrogenase | | |

TABLE VII
Several strucures of aromatic aminotransferase are among the list of
hits of proteins with surfaces similar to the functional site of
17-beta-hydrosysteroid dehydrogenase on 1 fdw.The listed hits all
have E-value ≦ 0.01 and are obtained by querying pvSOAR database
with the pattern obtained from pocket 39 of 1fdw.

| PDB | | | | | Full | |
|---|---|---|---|---|---|---|
| code | Pocket id | Chain id | E-value | Name | Sequence | Identity |
| 1fdw | 39 | 0 | 9.2e−30 | 17-Beta-Hydroxysteroid | 1.000 | 327 |
| | | | | Dehydrogenase | | |
| 1bhs | 30 | 0 | 9.3e−26 | 17-Beta-Hydroxysteroid | 0.994 | 327 |
| | | | | Dehydrogenase | | |
| 1fdv | 158 | D | 1.4e−22 | 17-Beta-Hydroxysteroid | 0.997 | 327 |
| | | | | Dehydrogenase | | |
| 1fdu | 156 | A | 3.2e−22 | 17-Beta-Hydroxysteroid | 0.997 | 327 |
| | | | | Dehydrogenase | | |
| 1equ | 82 | 0 | 2.2e−21 | Estradiol 17 Beta- | 0.994 | 327 |
| | | | | Dehydrogenase | | |
| 1fdv | 161 | C | 4.9e−20 | 17-Beta-Hydroxysteroid | 0.997 | 327 |
| | | | | Dehydrogenase | | |
| 1fdu | 154 | D | 5.9e−20 | 17-Beta-Hydroxysteroid | 0.997 | 327 |
| | | | | Dehydrogenase | | |
| 1fdv | 159 | A | 2.8e−19 | 17-Beta-Hydroxysteroid | 0.997 | 327 |
| | | | | Dehydrogenase | | |
| 1fdv | 160 | B | 1.1e−18 | 17-Beta-Hydroxysteroid | 0.997 | 327 |
| | | | | Dehydrogenase | | |
| 1fdu | 155 | B | 4.2e−18 | 17-Beta-Hydroxysteroid | 0.997 | 327 |
| | | | | Dehydrogenase | | |
| 1a27 | 31 | 0 | 5.2e−17 | 17-Beta-Hydroxysteroid- | 0.997 | 289 |
| | | | | Dehydrogenase | | |
| 1fdt | 32 | 0 | 4.3e−16 | 17-Beta-Hydroxysteroid- | 0.997 | 327 |
| | | | | Dehydrogenase | | |
| 1iol | 42 | 0 | 5.6e−15 | Estrogenic 17-Beta | 0.991 | 327 |
| | | | | Hydroxysteroid Dehy | | |
| 1equ | 81 | 0 | 3.8e−13 | Estradiol 17 Beta- | 0.994 | 327 |
| | | | | Dehydrogenase | | |
| 1dht | 35 | A | 5.6e−12 | Estrogenic 17-Beta | 0.994 | 327 |
| | | | | Hydroxysteroid Dehy | | |
| 1fdu | 156 | C | 1.5e−1l | 17-Beta-Hydroxysteroid | 0.997 | 327 |
| | | | | Dehydrogenase | | |
| 1fds | 31 | 0 | 1.6e−11 | 17-Beta-Hydroxysteroid- | 0.997 | 327 |
| | | | | Dehydrogenase | | |
| 3dhe | 43 | A | 4.3e−11 | Estrogenic 17-Beta | 0.994 | 327 |
| | | | | Hydroxysteroid Dehy | | |
| 2ay5 | 110 | A | 0.00053 | Aromatic Amino Acid | 0.276 | 58 |
| | | | | Aminotransferase | | |
| 2ay4 | 124 | A | 0.0032 | Aromatic Amino Acid | 0.276 | 58 |
| | | | | Aminotransferase | | |
| 2ay8 | 120 | A | 0.0084 | Aromatic Amino Acid | 0.276 | 58 |
| | | | | Aminotransferase | | |

TABLE VIII
Significant pocket matches between proteins from different superfamily
classifications.

| Query | | | Hit | | | | | | | | |
|---|---|---|---|---|---|---|---|---|---|---|---|
| PDB | Pocket | Chain | PDB | Pocket | Chain | Seq Align | | Pocket | | Sphere | |
| code | id | id | code | id | id | E() | Atoms | Rmsd | P() | Rmsd | P() |
| 1f6k | 40 | A | 1fvp | 76 | A | 5.2e−03 | 5 | 2.72 | 3.7e−01 | 0.53 | 1.5e−03 |
| 4rub | 298 | A | 1de6 | 227 | A | 2.6e−03 | 5 | 2.87 | 3.7e−01 | 0.75 | 1.9e−01 |
| 1jlx | 42 | A | 1abr | 75 | B | 9.1e−03 | 5 | 3.36 | 3.0e−01 | 0.95 | 3.6e−01 |
| 1gg1 | 104 | C | 1a49 | 551 | B | 9.1e−03 | 6 | 5.31 | 7.9e−02 | 0.85 | 3.3e−01 |
| 1tcm | 150 | B | 1bwv | 366 | A | 9.1e−03 | 6 | 5.71 | 9.4e−02 | 0.80 | 2.8e−01 |
| 1cil | 74 | B | 6ald | 132 | A | 3.0e−03 | 5 | 6.05 | 3.9e−02 | 0.57 | 5.4e−03 |
| 1fdy | 107 | B | 1a3w | 134 | B | 5.5e−03 | 6 | 6.07 | 4.3e−02 | 0.61 | 2.2e−02 |
| 1cec | 18 | 0 | 1muc | 103 | A | 1.4e−03 | 6 | 7.37 | 1.1e−02 | 0.59 | 1.1e−02 |

TABLE IX
Significant pocket matches between proteins from different fold classifications.

| | | | Hit | | | Seq | | | | | |
|---|---|---|---|---|---|---|---|---|---|---|---|
| Query | | | PDB | Pocket | Chain | Align | | Pocket | | Sphere | |
| PDB code | Pocket id | Chain id | code | id | id | E() | Atoms | Rmsd | P() | Rmsd | P() |
| 1x1a | 116 | B | 1esn | 145 | A | 5.3e−03 | 7 | 2.30 | 2.2e−01 | 0.35 | 2.2e−24 |
| 1fw6 | 148 | B | 1fdu | 155 | B | 1.0e−02 | 5 | 2.53 | 3.4e−01 | 0.24 | 2.8e−18 |
| 1bxk | 53 | A | 1e4o | 242 | A | 9.4e−03 | 6 | 2.60 | 3.1e−01 | 0.40 | 1.6e−07 |
| 1g0b | 36 | A | 1mng | 62 | A | 2.7e−03 | 6 | 2.53 | 3.4e−01 | 0.48 | 1.1e−04 |
| 1tcs | 32 | 0 | 1c8z | 42 | A | 7.9e−03 | 6 | 2.91 | 3.6e−01 | 0.55 | 2.6e−03 |
| 1bbt | 71 | 1 | 1hil | 105 | A | 2.0e−03 | 6 | 2.91 | 3.7e−01 | 0.59 | 1.0e−02 |
| 1vwl | 19 | B | 1djg | 134 | A | 5.1e−03 | 5 | 2.99 | 3.5e−01 | 0.67 | 6.6e−02 |
| 1qsl | 76 | A | 1djy | 125 | B | 1.0e−02 | 7 | 3.68 | 3.6e−01 | 0.35 | 3.3e−25 |
| 1dlv | 169 | C | 1eg5 | 113 | A | 1.6e−03 | 5 | 3.65 | 3.2e−01 | 0.34 | 1.3e−10 |
| 1qnc | 54 | B | 1bnc | 122 | B | 9.1e−03 | 8 | 3.83 | 3.6e−01 | 0.60 | 9.1e−09 |
| 1fqh | 71 | A | 1dv2 | 119 | A | 3.5e−04 | 7 | 3.27 | 3.6e−01 | 0.56 | 5.0e−06 |
| 1ded | 116 | B | 1am4 | 141 | F | 1.0e−02 | 6 | 3.95 | 3.2e−01 | 0.44 | 8.2e−06 |
| 1qgk | 104 | A | 1run | 65 | A | 3.4e−03 | 6 | 3.83 | 2.9e−01 | 0.46 | 2.9e−05 |
| 1axy | 41 | 0 | 1bpo | 138 | B | 7.8e−03 | 6 | 3.87 | 3.6e−01 | 0.47 | 6.3e−05 |
| 1b43 | 48 | A | 1bi3 | 37 | A | 9.7e−03 | 6 | 3.04 | 3.7e−01 | 0.49 | 1.5e−04 |
| 1ggj | 488 | C | 1qpk | 52 | A | 5.3e−03 | 8 | 3.36 | 3.5e−01 | 0.70 | 2.7e−04 |
| 1ecc | 105 | B | 1fhu | 37 | A | 3.7e−03 | 7 | 3.66 | 3.7e−01 | 0.60 | 1.3e−04 |
| 1lbh | 129 | B | 1guk | 79 | A | 9.9e−03 | 6 | 3.06 | 3.5e−01 | 0.55 | 3.5e−03 |
| 1pfx | 53 | C | 1nbm | 297 | B | 7.2e−03 | 6 | 3.13 | 3.6e−01 | 0.62 | 2.9e−02 |
| 1fu4 | 142 | A | 1rnh | 24 | 0 | 7.5e−03 | 6 | 3.23 | 3.7e−01 | 0.69 | 9.3e−02 |
| 1bza | 30 | 0 | 1gcx | 102 | A | 7.1e−03 | 6 | 3.27 | 3.6e−01 | 0.67 | 7.3e−02 |
| 1cx6 | 11 | A | 2shp | 127 | A | 3.2e−03 | 5 | 3.35 | 3.0e−01 | 0.66 | 5.6e−02 |
| 1b3o | 81 | B | 1vfd | 51 | 0 | 9.3e−03 | 7 | 3.49 | 3.7e−01 | 0.70 | 1.5e−02 |
| 2gsa | 107 | B | 1cj4 | 57 | A | 4.4e−03 | 7 | 3.53 | 3.5e−01 | 0.65 | 1.6e−03 |
| 3fru | 170 | E | 1aw7 | 146 | D | 5.8e−03 | 6 | 3.79 | 3.0e−01 | 0.61 | 1.9e−02 |
| 1btl | 75 | A | 1f3a | 65 | A | 7.9e−03 | 7 | 3.81 | 3.0e−01 | 0.78 | 8.8e−02 |
| 1el8 | 42 | A | 1jnk | 45 | 0 | 4.1e−03 | 5 | 3.03 | 3.4e−01 | 0.63 | 3.3e−02 |
| 1a8r | 178 | D | 1c4g | 160 | A | 9.2e−03 | 6 | 3.91 | 2.5e−01 | 0.71 | 1.3e−01 |
| 1xib | 32 | 0 | 1cke | 13 | A | 7.1e−03 | 6 | 4.46 | 1.7e−01 | 0.56 | 5.2e−03 |
| 1e8y | 117 | A | 1cpc | 71 | A | 5.7e−03 | 7 | 4.04 | 3.4e−01 | 0.72 | 2.3e−02 |
| 1fj2 | 42 | B | 1d0v | 34 | A | 5.6e−03 | 7 | 4.15 | 2.9e−01 | 0.70 | 1.2e−02 |
| 1bgm | 996 | K | 1d2c | 76 | B | 1.1e−03 | 8 | 4.24 | 3.6e−01 | 0.72 | 1.3e−03 |
| 1d2c | 64 | B | 1edg | 67 | 0 | 7.0e−03 | 6 | 4.34 | 2.1e−01 | 0.68 | 8.7e−02 |
| 1ds9 | 25 | A | 1e4y | 38 | A | 6.5e−03 | 6 | 4.49 | 1.9e−01 | 0.68 | 7.8e−02 |
| 1ac1 | 56 | A | 1cf4 | 40 | A | 9.8e−03 | 6 | 4.77 | 1.3e−01 | 0.58 | 1.0e−02 |
| 2f3g | 37 | A | 1b8a | 118 | A | 7.7e−03 | 7 | 4.82 | 1.9e−01 | 0.76 | 6.2e−02 |
| 1dbw | 28 | B | 1fcj | 120 | A | 9.5e−03 | 7 | 4.98 | 2.2e−01 | 0.70 | 1.5e−02 |
| 1g5r | 12 | A | 1yaa | 234 | B | 5.9e−03 | 8 | 4.43 | 3.0e−01 | 0.85 | 1.1e−01 |
| 1dc1 | 95 | A | 2gyi | 98 | A | 1.0e−02 | 8 | 5.69 | 2.5e−01 | 0.43 | 4.3e−31 |
| 1edo | 17 | A | 1b52 | 90 | A | 5.9e−03 | 6 | 5.07 | 1.1e−01 | 0.64 | 4.4e−02 |
| 1al0 | 185 | 2 | 2mgc | 20 | 0 | 9.0e−03 | 9 | 5.20 | 2.6e−01 | 0.75 | 1.0e−04 |
| 1fvj | 52 | B | 1tub | 166 | A | 1.0e−02 | 9 | 5.26 | 2.6e−01 | 0.90 | 1.1e−01 |
| 1dyn | 30 | B | 1tui | 153 | A | 9.0e−03 | 6 | 5.28 | 9.3e−02 | 0.46 | 2.7e−05 |
| 1dpz | 74 | B | 1sma | 184 | A | 6.9e−03 | 7 | 5.51 | 1.1e−01 | 0.76 | 6.2e−02 |
| 1aih | 105 | C | 1ddk | 29 | A | 5.2e−03 | 8 | 5.67 | 1.4e−01 | 0.86 | 1.3e−01 |
| 1c5c | 65 | L | 1aoq | 149 | A | 6.4e−03 | 9 | 5.83 | 2.3e−01 | 0.88 | 6.6e−02 |
| 1sid | 291 | A | 1vzv | 28 | 0 | 8.3e−04 | 7 | 5.84 | 2.4e−01 | 0.64 | 1.3e−03 |
| 1pky | 172 | C | 1g4w | 56 | R | 5.2e−03 | 9 | 6.10 | 1.6e−01 | 0.84 | 1.8e−02 |
| 1e7m | 62 | A | 1e1m | 55 | A | 6.4e−03 | 6 | 7.58 | 9.3e−03 | 0.71 | 1.3e−01 |
| 1nsi | 184 | B | 1sox | 146 | B | 3.0e−03 | 7 | 7.91 | 1.3e−02 | 0.79 | 1.2e−01 |
| 1fdw | 39 | 0 | 2ay5 | 110 | A | 2.1e−03 | 15 | 9.58 | 1.2e−01 | 1.02 | 3.6e−02 |

TABLE X
Significant pocket matches between proteins from different classes.

| Query | | | Hit | | | | | | | | |
|---|---|---|---|---|---|---|---|---|---|---|---|
| PDB | Pocket | Chain | PDB | Pocket | Chain | Seq Align | | Pocket | | Sphere | |
| code | id | id | code | id | id | E() | Atoms | Rmsd | P() | Rmsd | P() |
| 1qm4 | 76 | A | 2cua | 29 | B | 7.8e−03 | 5 | 2.81 | 3.2e−01 | 0.37 | 1.2e−08 |
| 1c1a | 28 | 0 | 1a28 | 70 | B | 2.6e−03 | 7 | 3.98 | 3.7e−01 | 0.68 | 5.3e−03 |
| 1feb | 95 | A | 1stg | 15 | 0 | 7.9e−03 | 7 | 3.50 | 3.6e−01 | 0.66 | 3.2e−03 |
| 1ell | 68 | A | 2hrv | 37 | B | 8.2e−03 | 6 | 3.57 | 3.4e−01 | 0.71 | 1.3e−01 |
| 1dr8 | 67 | B | 1vnf | 67 | 0 | 9.9e−04 | 8 | 4.60 | 2.6e−01 | 0.72 | 9.1e−04 |
| 1bra | 14 | 0 | 1dls | 21 | 0 | 1.8e−03 | 8 | 4.32 | 3.0e−01 | 0.69 | 1.6e−04 |
| 1gbk | 11 | A | 1bj4 | 71 | A | 6.9e−03 | 6 | 4.18 | 3.4e−01 | 0.56 | 4.5e−03 |
| 51pr | 14 | A | 1bj4 | 71 | A | 1.0e−02 | 6 | 4.24 | 3.4e−01 | 0.57 | 5.8e−03 |
| 1gc9 | 36 | A | 1vnf | 67 | 0 | 3.3e−03 | 8 | 4.58 | 2.7e−01 | 0.72 | 1.4e−03 |
| 1dgd | 50 | 0 | 1cmc | 28 | B | 9.8e−03 | 6 | 4.37 | 2.2e−01 | 0.74 | 1.8e−01 |
| 1gke | 65 | C | 1e3h | 65 | A | 4.1e−03 | 7 | 4.60 | 1.8e−01 | 0.96 | 3.7e−01 |
| 1cc6 | 44 | A | 1mac | 57 | A | 2.2e−03 | 7 | 4.72 | 2.0e−01 | 0.84 | 2.1e−01 |
| 1enp | 40 | 0 | 4csc | 62 | 0 | 2.1e−03 | 7 | 4.89 | 3.1e−01 | 0.83 | 1.9e−01 |
| 1cwu | 68 | A | 4csc | 62 | 0 | 2.1e−03 | 7 | 4.91 | 3.1e−01 | 0.82 | 1.8e−01 |
| 1bar | 38 | B | 1sek | 70 | 0 | 4.0e−03 | 7 | 4.99 | 1.3e−01 | 0.81 | 1.5e−01 |
| 1ecx | 73 | B | 1avh | 78 | A | 5.8e−03 | 8 | 7.00 | 4.9e−02 | 0.58 | 8.5e−10 |
| 1yes | 33 | 0 | 5hvp | 21 | B | 8.0e−03 | 10 | 7.21 | 1.2e−01 | 0.73 | 2.3e−05 |

We claim:

1. A method of identifying similar surface motifs of molecular sequences comprising:
a) identifying surface motifs of a plurality of molecular sequences;
b) identifying subsequences consisting of groups of atoms from the molecular sequences associated with the surface motifs;
c) generating a plurality of comparison metrics by comparing a first identified subsequence with a plurality of identified subsequences;
d) calculating the statistical significance of at least one of the comparison metrics; and
e) identifying molecular sequences that are similar to the molecular sequence corresponding to the first identified subsequence based on the statistical significance of the comparison metrics.

2. The method of claim 1 wherein the molecular sequences are derived from proteins, DNA, RNA, polysaccharides and other polymeric molecules.

3. The method of claim 1 wherein the surface motifs are pockets.

4. The method of claim 1 wherein the surface motifs are voids.

5. The method of claim 1 wherein the surface motifs are active sites, ligand binding sites, cofactor binding sites and inhibitor binding sites.

6. The method of claim 1 wherein the subsequences are composed of groups of atoms forming the surface motifs.

7. The method of claim 6 wherein the groups of atoms are amino acids, nucleotides or saccharides.

8. The method of claim 6 wherein the group of atoms are involved with binding a ligand, cofactor, substrate, substrate analogue or inhibitor.

9. The method of claim 1 wherein the step of identifying surface motifs is performed by a Delaunay triangulation or a Voronoi diagram.

10. The method of claim 9 wherein the step of identifying surface motifs is performed using alpha shape computation.

11. The method of claim 1 wherein the step of generating a plurality of comparison metrics is performed using signature composition distributions.

12. The method of claim 1 wherein the step of generating a plurality of comparison metrics is performed using distribution entropy.

13. The method of claim 1 wherein the step of generating a plurality of comparison metrics is performed using Smith-Waterman algorithm.

14. The method of claim 1 wherein the step of generating a plurality of comparison metrics is performed using a substitution scoring matrix assembled by measuring changes accompanying substituting one group of atoms for another group of atoms.

15. The method of claim 1 wherein the step of generating a plurality of comparison metrics is performed by calculating the root-mean-square distances of the first identified subsequences to the plurality of identified subsequences.

16. The method of claim 1 wherein the step of calculating the statistical significance of the comparison metrics is performed by the method comprising the steps of:
a. generating a plurality of random comparison metrics by comparing the first identified subsequence with a plurality of random subsequences derived from randomizing the groups of atoms comprising the plurality of identified subsequences;
b. determining distribution parameters associated with the plurality of random comparison metrics; and
c. determining a probability of randomly obtaining a particular comparison metric from the plurality of comparison metrics using the distribution parameters.

17. The method of claim 16 wherein the step of determining the probability of randomly obtaining a particular comparison metric from the plurality of comparison metrics using the distribution parameters is performed using an equation describing the relationship:
$$p ( Z > {z}_{i} ) = 1 - exp ( {ⅇ}^{\frac{{z}_{i} π}{\sqrt{6}} - {Γ}^{′} ( 1 )} ) ,$$
wherein zₗ=(Sᵢ−μ)/σ and wherein the distribution parameters are the mean, μ, and the standard deviation, σ, of the random comparison metrics, and the particular metric from the plurality of comparison metrics is given by Sᵢ.

18. The method of claim 17 further comprising the step of multiplying the probability p by the number of comparison metrics considered.

19. The method of claim 16 further comprising the step of determining whether the distribution of the plurality of random comparison metrics is consistent with a distribution that explains the characteristic of the distribution of the plurality of random comparison metrics.

20. The method of claim 19 wherein the step of determining whether the plurality of random comparison metrics are consistent with a distribution that explains the characteristics of the distribution of the plurality of random comparison metrics is performed using a Kolmogorov-Smirnov goodness-of-fit test.

21. The method of claim 16 wherein a subset of the plurality of random comparison metrics are used in determining distribution parameters.

22. The method of claim 1 further comprising the step of determining whether the comparison metrics are consistent with a distribution that explains the characteristic of the distribution of the plurality of comparison metrics.

23. The method of claim 22 wherein a subset of the plurality of comparison metrics are used in determining whether the comparison metrics are consistent with a distribution that explains the characteristic of the distribution of the plurality of comparison metrics.

24. A method of identifying similar molecular sequences comprising:
a) generating a plurality of comparison metrics by comparing a first identified subsequence with a plurality of identified subsequences wherein the subsequences consist of groups of atoms associated with surface motifs of a plurality of molecular sequences;
b) calculating the statistical significance of at least one of the comparison metrics;
c) identifying molecular sequences that are similar to the molecular sequence corresponding to the first identified subsequence based on the statistical significance of the comparison metrics; and
d) generating a plurality of geometric comparison metrics of the first identified subsequence with a plurality of identified subsequences corresponding to the statistically significant comparison metrics.

25. The method of claim 24 wherein the molecular sequences are derived from proteins, DNA, RNA and polysaccharides.

26. The method of claim 24 wherein the surface motifs are pockets.

27. The method of claim 24 wherein the surface motifs are voids.

28. The method of claim 24 wherein the surface motifs are active sites, ligand binding sites, cofactor binding sites and inhibitor binding sites.

29. The method of claim 24 wherein the subsequences are composed of groups of atoms forming the structural features.

30. The method of claim 29 wherein the groups of atoms are amino acids, nucleotides or saccharides.

31. The method of claim 29 wherein the group of atoms are involved with binding a ligand, cofactor, substrate, substrate analogue or inhibitor.

32. The method of claim 24 wherein the step of identifying surface motifs is performed by a Delaunay triangulation or a Voronoi diagram

33. The method of claim 32 wherein the step of identifying surface motifs is performed using alpha shape computation.

34. The method of claim 24 wherein the step of generating a plurality of comparison metrics is performed using signature composition distributions.

35. The method of claim 24 wherein the step of generating a plurality of comparison metrics is performed using distribution entropy.

36. The method of claim 24 wherein the step of generating a plurality of comparison metrics is performed using Smith-Waterman algorithm.

37. The method of claim 24 wherein the step of generating a plurality of comparison metrics is performed using a substitution scoring matrix assembled by measuring changes accompanying substituting one group of atoms to another group of atoms.

38. The method of claim 24 wherein the step of generating a plurality of comparison metrics is performed by calculating the root-mean-square distances of the first identified subsequences to the plurality of identified subsequences.

39. The method of claim 24 wherein the step of calculating the statistical significance of the comparison metrics is performed by the method comprising the steps of:
a. generating a plurality of random comparison metrics by comparing the first identified subsequence with a plurality of random subsequences derived from randomizing the groups of atoms comprising the plurality of identified subsequences;
b. determining distribution parameters associated with the plurality of random comparison metrics; and
c. determining the probability of randomly obtaining a particular comparison metric from the plurality of comparison metrics using the distribution parameters.

40. The method of claim 39 wherein the step of determining the probability of randomly obtaining a particular comparison metric from the plurality of comparison metrics using the distribution parameters is performed using the following relationship:
$$p ( Z > {z}_{i} ) = 1 - exp ( {ⅇ}^{\frac{{z}_{i} π}{\sqrt{6}} - {Γ}^{′} ( 1 )} ) ,$$
wherein zₗ=(Sₗ−μ)/σ and wherein the distribution parameters are the mean, μ, and the standard deviation, σ, of the random comparison metrics, and the particular comparison metric from the plurality of the comparison metrics are given by Sᵢ.

41. The method of claim 40 further comprising the step of multiplying the probability p by the number of comparison metrics considered.

42. The method of claim 39 further comprising the step of determining whether the plurality of random comparison metrics are consistent with a distribution that explains the characteristics of the distribution of the plurality of random comparison metrics.

43. The method of claim 42 wherein the step of determining whether the plurality of random comparison metrics are consistent with a distribution that explains the characteristics of the distribution of the plurality of random comparison metrics is performed using a Kolmogorov-Smirnov goodness-of-fit test.

44. The method of claim 39 wherein a subset of the plurality of random comparison metrics are used in determining distribution parameters.

45. The method of claim 24 wherein the geometric comparison metric is generated by performing a root-mean-square-distance computation of the first identified subsequences to the plurality of identified subsequences.

46. The method of claim 24 wherein the geometric comparison metric is generated by performing a unit vector root-mean-square-distance computation of the first identified subsequences to the plurality of identified subsequences.

47. A method of identifying similar surface motifs of molecular sequences comprising:
a identifying surface motifs of a plurality of molecular sequences;
b identifying subsequences consisting of groups of atoms from the molecular sequences associated with the surface motifs;
c generating a plurality of comparison metrics by comparing a first identified subsequence with a plurality of identified subsequences; and
d identifying molecular sequences that are similar to the molecular sequence corresponding to the first identified subsequence based on the comparison metrics.

48. The method of claim 47 wherein the molecular sequences are derived from proteins, DNA, RNA, polysaccharides and other polymeric molecules.

49. The method of claim 47 wherein the surface motifs are pockets.

50. The method of claim 47 wherein the surface motifs are voids.

51. The method of claim 47 wherein the surface motifs are active sites, ligand binding sites, cofactor binding sites and inhibitor binding sites.

52. The method of claim 47 wherein the subsequences are composed of groups of atoms forming the surface motifs.

53. The method of claim 52 wherein the groups of atoms are amino acids, nucleotides or saccharides.

54. The method of claim 52 wherein the group of atoms are involved with binding a ligand, cofactor, substrate, substrate analogue or inhibitor.

55. The method of claim 47 wherein the step of identifying surface motifs is performed by a Delaunay triangulation or a Voronoi diagram.

56. The method of claim 55 wherein the step of identifying surface motifs is performed using alpha shape computation.

57. The method of claim 47 wherein the step of generating a plurality of comparison metrics is performed using signature composition distributions.

58. The method of claim 47 wherein the step of generating a plurality of comparison metrics is performed using a sequence-based comparison.

59. The method of claim 58 further comprising the steps of:
a generating a second plurality of comparison metrics based on the first identified subsequence and subsequences corresponding to the identified molecular sequences, using a geometric-based comparison; and
b identifying molecular sequences that are similar to the molecular sequence corresponding to the first identified subsequence based on the second plurality of comparison metrics.

60. The method of claim 47 wherein the step of generating a plurality of comparison metrics is performed using a sequence-based comparison.
